(19) United States
(12) Patent Application Publication
(10) Pub. No.: US 2010/0076843 A1
(43) Pub. Date: Mar. 25, 2010

(54) LIVE-AGENT-ENABLED TEIS SYSTEMS

(75) Inventor: Jason Ashton, Santa Cruz, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SpeakSoft, Inc., Santa Cruz, CA (US)

(21) Appl. No.: 12/604,621

(22) Filed: Oct. 23, 2009

Related U.S. Application Data
(63) Continuation-in-part of application No. 11/679,801, filed on Feb. 27, 2007.
(60) Provisional application No. 60/777,936, filed on Feb. 28, 2006.

(51) Int. Cl. G06Q 30/00

(52) U.S. Cl. 705/14.51; 705/26

(57) ABSTRACT

Systems for providing live-agent and hybrid live-agent access to transaction-enabled information systems are disclosed. In various embodiments, a live agent can include a person who using one or more communications devices can hear the utterances of a caller to the transaction-enabled information system and in response may respond verbally to the caller (e.g., by asking the caller for added information that the transaction-enabled information system would otherwise ask for by automated means), and/or may respond by making an input to the transaction-enabled information system (by keyboard, touch screen, verbally, or some other means) based upon the live agent's understanding of the caller's intention. In some embodiments, the transaction-enabled information system may be designed to switch to the live agent mode either automatically, when a specified requirement has been fulfilled and/or when a caller expresses an intention to proceed with the assistance of a live agent.

### CROSS-REFERENCES TO RELATED APPLICATIONS

This application is a continuation-in-part of commonly owned co-pending U.S. patent application Ser. No. 11/679,801, filed Feb. 27, 2007 and entitled “Transaction Enabled Information System,” which claims the benefit of and priority to U.S. Provisional Application No. 60/777,936, filed Feb. 28, 2006 and entitled “Transaction Enabled Information System,” the entire disclosures of these applications are incorporated by references herein for all purposes.

This Application is related to commonly owned co-pending U.S. patent application Ser. No. 11/679,804, filed Feb. 27, 2007 and entitled “Interactive 411 Directory Assistance,” the entire disclosure of which is incorporated by reference herein for all purposes.

### BACKGROUND OF THE INVENTION

The present invention relates to information systems. More specifically, the present invention relates to techniques for providing transaction-enabled information.

In general, telecommunication companies have generated billions in revenue by simply providing limited directory assistance information to traditionally landline, and more modernly, mobile phone subscribers. Typically, the average cost of a directory assistance call is $2.00, and may only last approximately 30 seconds. This scheme of providing simple directory assistance information has succeeded in the past as a result of the information being available only through the network of the telecommunication provider.

However, with the proliferation of new mobile devices with internet access and cost free services, such as 1-800-free-411, demand for simple directory assistance information is in serious decline. Therefore, telecommunication companies are currently experiencing a considerable deterioration in the usage of directory assistance services as a lack of perceived value (i.e., the approx. $2.00 per call on average) in the simple directory assistance information, and the ready availability of information from other sources, such as the Internet.

One problem though with current telecommunication and information systems is that they are not truly streamlined for natural human interaction. The two most conspicuous and fastest growing information systems in the modern era are the Internet and personal communications devices (primarily mobile devices). Despite the rapid adoption of both of these systems, they are only just beginning to converge. Even with the rapid and pervasive growth of convergence devices, one of the most frequent complaints from users of such systems is their usability. Current devices and systems require humans to learn how to use them instead of offering methods of user interaction that are already natural, social, and culturally normal.

Some problems with these new mobile devices with internet access is they generally tend to have small or feature reduced keypads/keyboards, and diminished screens that limit their usability. Furthermore, as new mobile devices with internet access proliferate, safety concerns increase as users are forced to interact manually with these mobile devices by typing, keying, or scrolling to obtain information while performing activities such as driving, ridding a bike, or event walking.

Accordingly, what is desired are improved methods and apparatus for solving the problems discussed above, while reducing the drawbacks discussed above.

### BRIEF SUMMARY OF THE INVENTION

The present invention relates to information systems. More specifically, the present invention relates to techniques for providing transaction-enabled information.

In various embodiments, a method for providing transaction-enabled information includes providing access to a plurality of sites. Each of the plurality of sites is associated with at least one transaction grammar. In general, a transaction grammar defines a set of messages related to a category, such as travel, product information, driving directions, and the like. User input is received indicative of one or more keywords associated with a category. The user input is analyzed to identify a first transaction grammar. A task is identified to determine information from one or more of the plurality of sites associated with the first transaction grammar. The task is then performed to generate, based on the first transaction grammar, a message indicative of a first transaction based on information received from the one or more of the plurality of sites.

In some embodiments, a live agent can include a person who using one or more communications devices can hear the utterances of a caller to the transaction-enabled information system and in response may respond verbally to the caller (e.g., by asking the caller for added information that the transaction-enabled information system would otherwise ask for by automated means), and/or may respond by making an input to the transaction-enabled information system (by keyboard, touch screen, verbally, or some other means) based upon the live agent's understanding of the caller's intention. In some embodiments, the transaction-enabled information system may be designed to switch to the live agent mode either automatically, when a specified requirement has been fulfilled and/or when a caller expresses an intention to proceed with the assistance of a live agent.

A further understanding of the nature and the advantages of the inventions disclosed herein may be realized by reference of the remaining portions of the specification and the attached drawings.

### BRIEF DESCRIPTION OF THE DRAWINGS

In order to more fully understand the present invention, reference is made to the accompanying drawings. Understanding that these drawings are not to be considered limitations in the scope of the invention, the presently described embodiments and the presently understood best mode of the invention are described with additional detail through use of the accompanying drawings.

FIG. 1 illustrates a transaction-enable information system that may incorporate embodiments of the present invention.

FIG. 2 is a block diagram of interactions between application servers of the transaction-enable information system of FIG. 1 in one embodiment according to the present invention.

FIG. 3 is a block diagram of a voice portal in one embodiment according to the present invention.

FIG. 4 is a block diagram of an application server for providing comparison shopping transactions in one embodiment according to the present invention.

FIG. 5 is a block diagram of an application server for providing advertisements in one embodiment according to the present invention.

FIG. 6 is a block diagram of an application server for providing personal information management in one embodiment according to the present invention.

FIG. 7 is a block diagram of an application server for providing user profiling in one embodiment according to the present invention.

FIG. 8 is a block diagram of an application server for providing location-based services in one embodiment according to the present invention.

FIG. 9 is a block diagram of an application server for providing directory assistance services in one embodiment according to the present invention.

FIG. 10 is a simplified flowchart for providing transaction-enabled information in one embodiment according to the present invention.

FIG. 11 is a simplified flowchart for providing interactive 411 directory assistance in one embodiment according to the present invention.

FIG. 12 is a flowchart for providing transaction-enabled directory assistance information in one embodiment according to the present invention.

FIG. 13 is a flowchart for providing transaction-enabled comparison shopping travel information in one embodiment according to the present invention.

FIG. 14 is a flowchart for providing transaction-enabled comparison shopping information related to travel itineraries in one embodiment according to the present invention.

FIG. 15 is a flowchart for providing transaction-enabled comparison shopping information related to products and/or services in one embodiment according to the present invention.

FIG. 16 is a flowchart for providing transactions related to auction services in one embodiment according to the present invention.

FIG. 17 is a flowchart for providing transactions related to order confirmation services in one embodiment according to the present invention.

FIG. 18 is a flowchart for providing transactions related to financial services in one embodiment according to the present invention.

FIG. 19 is a flowchart for providing transactions related to shipping services in one embodiment according to the present invention.

FIG. 20 is a flowchart for providing targeted advertising in one embodiment according to the present invention.

FIG. 21 is a flowchart for providing personal information management services in one embodiment according to the present invention.

FIG. 22 is a flowchart for providing calendaring services related to shipping services in one embodiment according to the present invention.

FIG. 23 is a flowchart for providing location-based services in one embodiment according to the present invention.

FIG. 24 is a flowchart for providing transactions provided by partnership services in one embodiment according to the present invention.

FIG. 25 is an illustration that depicts a live-agent-enabled transaction-enable information system in various embodiments according to the present invention.

FIG. 26 is a simplified illustration of a computer system that may incorporate an embodiment of the present invention.

### DETAILED DESCRIPTION OF THE INVENTION

The present invention relates to information systems. More specifically, the present invention relates to techniques for providing transaction-enabled information.

In various embodiments, dynamically improved directory assistance provides users with valuable transaction enabled information. In some embodiments, an impulse buy rich environment is provided such that information that is “content relevant” to the user is retrieve and conveyed to the user based on the user's verbal inputs.

Rather than limited directory assistance information only systems, in various embodiments, methods and apparatus deliver such content relevant information in a format that allows advertisers the ability to deliver advertising to highly qualified target markets based on the user's verbal input. For example, by analyzing the user's verbal input of “United Airlines,” queries and/or requests for content relevant information are made from a variety of sites and/or information partners, and tasks are initiated to perform and consummate various transactions.

Accordingly, methods and apparatus are disclosed that provide users and callers with succinct information, comparison shopping tools, bids for products or services, receive bid statuses that are transaction enabled, driving directions, and advertising that are based on keywords or phrases using primarily voice commands.

The following terms and phrases may be used throughout the disclosure:
Automatic Speech Recognition (ASR): Hardware and/or software elements that recognize a verbal utterance spoken by a user and matches the verbal utterance or a keyword associated with the verbal utterance to a transaction grammar.
Call Control: Hardware and/or software elements that receive, initiate, and terminate telephone calls.
Directory Assistance (DA): The standard information service provided by telephone companies to users who dial 411.
Dual-tone multi-frequency (DTMF): The ‘touch-tone’ interface used to signal the call switching center during a call.
Interactive Voice Response (IVR): Hardware and/or software elements that translate verbal utterances of a user (e.g., spoken words or phrases) into software commands, and provide feedback to the user using recorded speech or text to speech software.
Public Land Mobile Network (PLMN): Any wireless communications system intended for use by terrestrial subscribers in vehicles or on foot. Usually interconnected with a PSTN.
Public Switched Telephone Network (PSTN): Any land-line based telephone network. Also known as Plain Old Telephone System (POTS).
PSTN Gateway: Hardware and/or software elements that interface with the telephony network to connect telephone calls to an Internet protocol (IP) based enterprise application.
Text To Speech (TTS): Hardware and/or software elements that translate written text into audio output that simulates human speech.
Voice over IP (VOIP): Hardware and/or software elements that transmit voice data over IP networks.
Voice User Interface (VUI): Hardware and/or software elements that provide interaction between a user and a computer program in order to operate the computer program and receive feedback or information from the computer program.
Voice eXtensible Markup Language (VXML): Any markup language that enables software developers to quickly develop voice user interfaces for telecommunications systems.

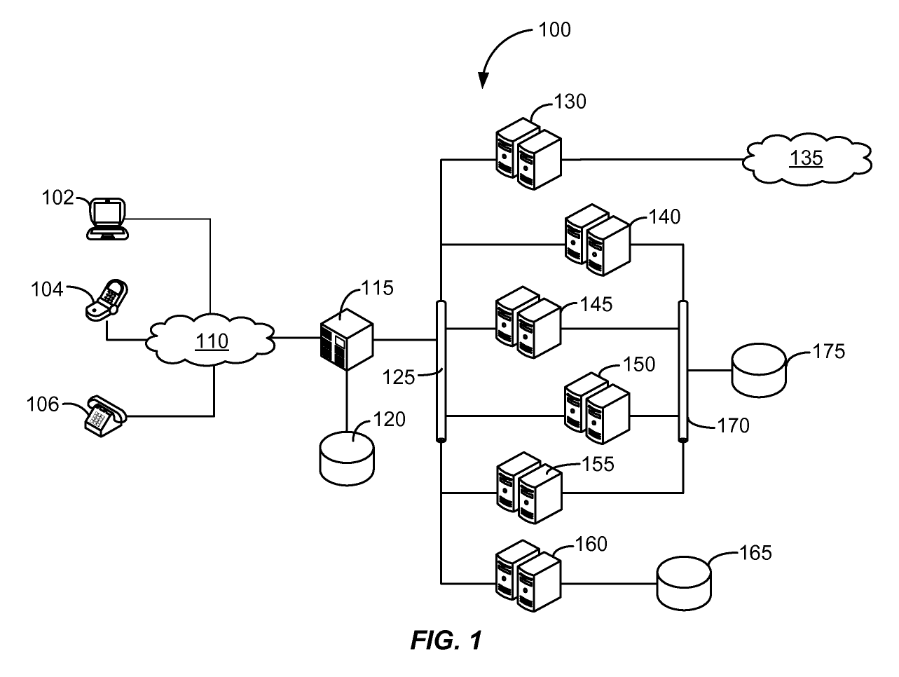

FIG. 1 illustrates a transaction-enable information system 100 that may incorporate embodiments of the present invention. In this example, system 100 includes a laptop computer 102, a mobile device 104, a telephone 106, a communications network 110, a voice portal 115, a transaction grammar and media storage 120, a network link 125, a comparison shopping (CS) application server 130, a communications network 135, an advertising (ADS) application server 140, a personal information manager (PIM) application server 145, a user profile (UPS) application server 150, a location-based (LBS) application server 155, a directory assistance (DA) application server 160, a directory information storage 165, a network link 170, and a storage 175.

Communications network 110 is linked to laptop computer 102, mobile device 104, telephone 106, and voice portal 115. Voice portal 115 is linked to transaction grammar and media storage 120. Network link 125 is linked to CS application server 130, ADS application server 140, PIM application server 145, UPS application server 150, location-based (LBS) application server 155, and DA application server 160. CS application server 130 is linked to communication network 135. DA application server 160 is linked to directory information storage 165. Network link 175 is linked to ADS application server 140, PIM application server 145, UPS application server 150, LBS application server 155, and storage 175.

Laptop computer 102 is intended to represent any computer system, such as desktops, workstations, notebooks, laptops, portable and ultra-portable computers, thin-clients, and the like. Mobile device 104 is intended to represent any mobile device, such as mobile phones, personal digital assistants (PDS), smartphones, pagers, and the like. Telephone 106 is intended to represent landline phones and traditional non-mobile communication devices.

Communications network 110 provides calls, sessions, connections, and the like between laptop computer 102, mobile device 104, and telephone 106 and voice portal 115. Some examples of communications network 110 are POTS/PSTN networks, PLMN networks, cellular networks, the Internet, Wifi and WiMax networks, private and public networks, VOIP networks, and the like.

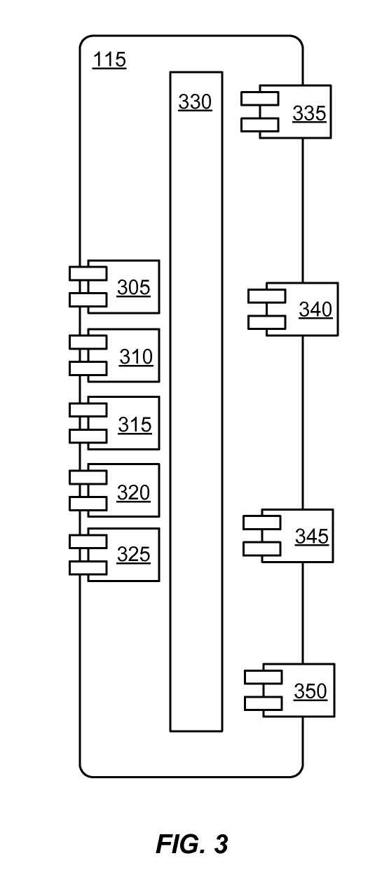

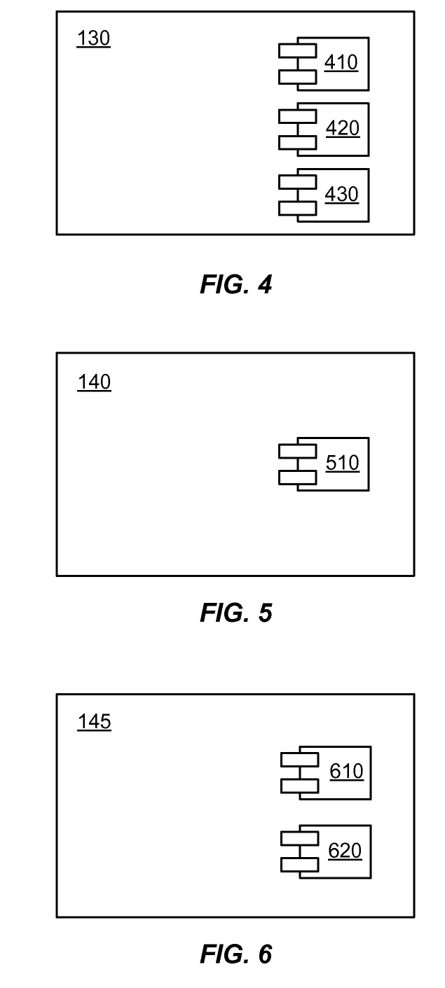

Voice portal 115 is any hardware and/or software elements that provide a VUI and IVR interactions. One example of voice portal 115 is described further below with respect to FIG. 3. CS application server 130 is any hardware and/or software elements that access data to perform travel related comparison shopping, product comparison shopping, and execute comparison shopping transactions. One example of CS application server 130 is described below with respect to FIG. 4. One example of communications network 135 is the Internet.

ADS application server 140 is any hardware and/or software elements that provide ads to users of voice portal 115 based on verbal input of the user. One example of ADS server 140 is described further below with respect to FIG. 5. PIM application server 145 is any hardware and/or software elements that provide unified messaging. Some examples of unified message include offering IVR enabled access to voice mail, TTS rendering of e-mail and text messages, and the like. One example of PIM application server 145 is described further below with respect to FIG. 6.

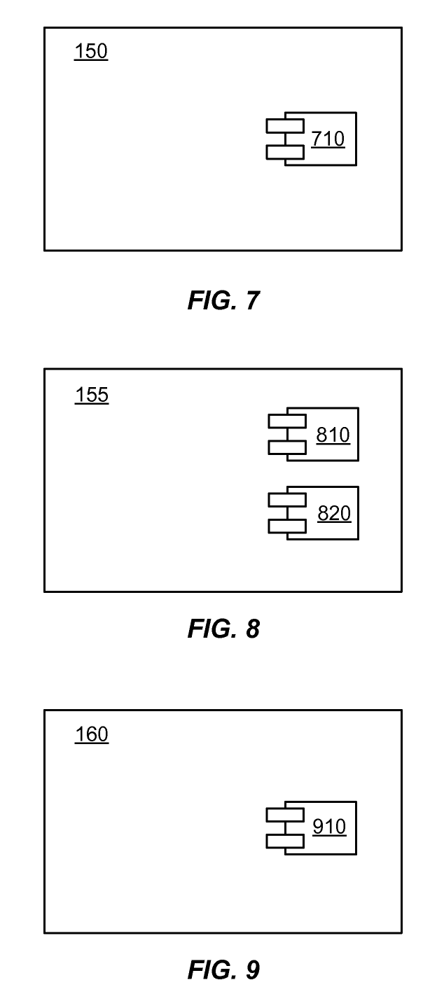

UPS application server 150 is any hardware and/or software elements that stores user profile data. User profile data is any information associated with a user or caller, such as a telephone number, IP or network address, billing information, shipping information, and the like. One example of UPS application server 150 is described further below with respect to FIG. 7. LBS application server 155 is any hardware and/or software elements that provide location based services, such as global positioning (GPS) and the like. One example of LBS application server is described further below with respect to FIG. 8. DA application server 160 is any hardware and/or software elements that provide directory assistance information. One example of DA application server 160 is described further below with respect to FIG. 9.

In one example of operation, system 100 provides a user of laptop computer 102, mobile device 104, and telephone 106, access to the Internet for information that is relevant or associated with the user's specific queries or request(s). In general, system 100 receives input from a user. The input from the user may be verbal input or utterances, spoken words or phrases, a cough or sneeze, touch tones, mouse clicks, stylus presses, key presses, and the like.

System 100 then analyzes the input from the user, such as verbal utterances, to determine one or more transactions grammars. A transaction grammar defines one or more messages related to a category, such as travel, product information, driving directions, and the like. In general, system 100 matches one or more keywords or phrases uttered by a user to a transaction grammar, and conveys messages to the user based on the transaction grammar.

The messages defined by a transaction grammar may indicate information related the category, offers to perform tasks for the user that are related to the category, offers to initiate or consummate category specific transactions, or deliver advertisements associated with the category. The messages may be static, such as prerecorded product information, or dynamically generated, such as using TTS.

For example, in response to a verbal request from a user for a listing associated with “United Airlines,” system 100 determines a transaction grammar related to travel or airfares. In another example, system 100 delivers messages indicating content relevant information and advertising based on a transaction grammar associated with the user's queries or requests.

The following illustrates one example of an exchange between a user and system 100:

System 100: “What city please?”

User: “San Francisco”

System 100: “What listing please?”

User: “United Airlines”

System 100 determines a transaction grammar related to the phrase “United Airlines,” and conveys a message to the user based on the transaction grammar.

System 100: “Would you like me to help you find the lowest price for an itinerary?”

User: “No”

System 100 determines another messages based on the transaction grammar, and conveys the message to the user.

System 100: “Did you know American Airlines will give you 5000 extra travel miles if you connect to them now and purchase your ticket today. Would you like me to connect you to American Airlines instead of United Airlines?”

In various embodiments, system 100 provide users with valuable tools and features such as comparison-shopping, bidding features for products or services, receive status of bids that are transaction enabled, access product reviews, order and pay for goods and services using primarily voice commands via voice portal 115.

In some embodiments, system 100 provides standard calendaring, tasks based on itinerary, hotel confirmation, and the like, and messages indicating other organic factors, such as traffic conditions, flight delays, and actual user location.

In some embodiments, system 100 provides merchants with tools that will help influence and potentially redirect a highly qualified prospect's buying decision based on queries and/or requests made by the user in the past or in real time. In addition, special offers can be made based on the same or additional queries or requests for information. System 100 saves profiles of users' call data (e.g., using application server 150) and utilizes location sensitive data and user utterances to narrow and qualify the users' preferences. In some embodiments, system 100 stores the data as a component of PIM application server 145 for faster data mining, identifying, and setting user preferences, as well as for performing specific tasks for the user based on past experiences and in real time.

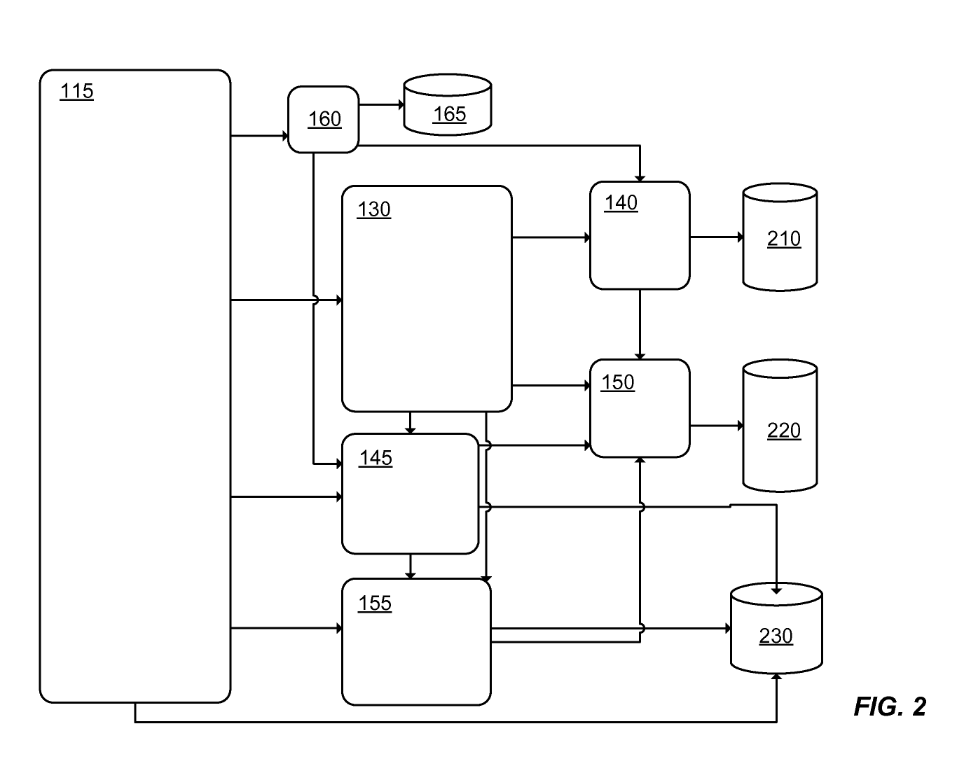

FIG. 2 is a block diagram of interactions between application servers of the transaction-enable information system 100 of FIG. 1 in one embodiment according to the present invention. In this example, voice portal 115 interacts with DA application server 160, CS application server 130, PIM application server 145, LBS application 155 based on verbal input from a user.

In various embodiments, users using only voice commands or verbal utterances can research buying decisions, receive driving directions via GPS, find the lowest price product and/or services, such as airline tickets and hotels, bid on items or offer to pay their own price, receive notification of bid status via wireless device, landline, etc., find the lowest price for electronics, automobiles, etc, check inventory levels via GPS, and purchase and download media.

DA application server 160 retrieves directory assistance information from directory assistance information storage 165 based on instructions from voice portal 115. DA application server 160 returns the retrieved directory assistance information to voice portal 115, which audibly conveys the directory assistance information to the user.

As shown in FIG. 2, DA application server 160 may additionally interact with ADS application server 140 to provide ads related to the retrieved directory assistance information from ads storage 210. DA application server 160 may also interact with PIM application server 145 to send the directory assistance information to the user via e-mail, or other communication methods coordinated by PIM application server 145.

CS application server 130 retrieves comparison shopping information based on instructions from voice portal 115. Comparison shopping information is any information related products and/or services, such as travel destinations, hotel reservations, movie and theater tickets, price information, product availability information, and the like.

As shown in FIG. 2, CS application server 130 may additionally interact with ADS application server 140 to provide ads related to the retrieved comparison shopping information. CS application server 130 may also interact with UPS application server 150 to obtain user profile data from user profile storage 220 to assist in the determination and retrieval of the comparison shopping information. CS application server 130 may interact with PIM application server 145 to send the comparison shopping information to the user via e-mail, or other communication methods coordinate by PIM application server 145. CA application server 130 may further interact with LBS application server 155 to provide location services based on the comparison shopping information, such as the location and driving directions to the store where a product is currently available for purchase.

PIM application server 145 provides access to unified messaging services, such as voice mail, e-mail, and the like, to the user based on instructions from voice portal 115. As shown in FIG. 2, PIM application server 145 may interact with UPS application server 150 to set or retrieve preferences or parameters stored in user profile data. PIM application server 145 may also interact with LBS application server 155 to have location-based information sent to the user via e-mail, or other communication methods coordinate by PIM application server 145.

LBS application server 155 provides location-based services, such as GPS information and driving directions, based on instructions from voice portal 115. Voice portal 115, PIM application server 145, and LBS application server 155 may retrieve data and messages from storage 230 to provide audible information to the user.

FIG. 3 is a block diagram of voice portal 115 in one embodiment according to the present invention. In this example, voice portal 115 includes an ASR module 305, a TTS module 310, an audio module 315, a DTMF module 320, a telephony module 325, a CCXML routing module 330, a directory assistance VXML module 335, a comparison shopping VXML module 340, a personal information manager VXML module 345, and a location-based services VXML module 350.

ASR module 305 includes hardware and/or software elements that translate or convert verbal input of a user to text. In various embodiments, AST module 305 includes high quality ASR with support for regional dialects and multiple languages. TTS module 310 includes hardware and/or software elements that convert text to speech. In various embodiments, TTS module 310 includes high quality TTS support with configurable “voices.”

Audio module 315 includes hardware and/or software elements that output audio. DTMF module 320 includes hardware and/or software elements that provide a touch tone interface to voice portal 115. As a fallback, DTMF module 320 provides user interaction scripts to DTMF support with prompted menus for frustrated users who request assistance. Telephony module 325 includes hardware and/or software elements that provide call control.

CCXML routing module 330 includes hardware and/or software modules that provide telephony call control support for VoiceXML or other dialog systems using the Call Control XML (CCXML) markup language. In general, VoiceXML (VXML) is designed for creating audio dialogs that feature synthesized speech, digitized audio, recognition of spoken and DTMF key input, recording of spoken input, telephony, and mixed initiative conversations.

Directory assistance VXML module 335 includes hardware and/or software elements that receive directory assistance information (e.g., from DA application server 160) to generate messages to the user related to the directory assistance information. Comparison shopping VXML module 340 includes hardware and/or software elements that receive comparison shopping information (e.g., from CS application server 130) to generate messages to the user related to the comparison shopping information.

Personal information manager VXML module 345 includes hardware and/or software elements that interface with unified messaging services (e.g., PIM application server 145) to provide access to retrieve voicemail, send and receive e-mail, and the like. Location-based services VXML module 350 includes hardware and/or software elements that receive location information (e.g., from LBS application server 155) and generate messages to the user related to the location information.

In various embodiments, voice portal 115 provides a type of web portal. Voice portal 115 may provide access to any information or service on the Internet or internally hosted. Accordingly, voice portal 115 performs ASR, TTS, and call control for a user's interaction and remotely invokes services to execute business logic and the actual lookups of information and services.

In some embodiments, voice portal 115 provides scalable call volume handling and routing, high quality ASR with support for regional dialects and multiple languages, the ability to learn and store user profile data associated with identified callers to improve IVR capabilities, high quality TTS support with configurable “voices,” recorded human audio, and a natural language user experience. In various embodiments, voice portal 115 provides user interaction scripts to offer alternate voice prompts and DTMF support with prompted menus for frustrated users who request assistance during navigation of various menus and prompts.

In one example of operation, voice portal 115 implements IVR using ASR module 305 to translate speech to text to enable users with voice access to the Internet. For example, the user of mobile device 104 does not need to look at or use a touch screen styluses or a keypad associated with mobile device 104 to access information. System 100 provides the information requested by the user of mobile device 104 via voice portal 115.

In some embodiments, voice portal 115 includes support for Natural Language Commands (NLC) to allow users and callers to give verbal input without waiting for prompting from voice portal 115. For example: After entering a menu directed to the lowest airfare, a user may issue the following: “I need 1 ticket from San Jose, Calif. to New York, N.Y. on February 14th, returning on February 16th.” Voice portal 115 breaks apart the commands in the verbal input to execute a request for travel information.

FIG. 4 is a block diagram of CS application server 130 for providing comparison shopping transactions in one embodiment according to the present invention. In general, CS application server 130 provides access to a plurality of sites. For example, one or more sites provide shopping services that allow a user to perform travel related comparison shopping, product comparison shopping, and execute transactions without leaving system 100, or to be connected to a partner service provider to consummate transactions. For example, CS application server 130 may search for availability of products and/or services that match a callers entered search parameters (e.g., one or more keywords in the user's verbal utterances). These search parameters may depend on the type of product and/or service, such as an itinerary, a product name, a model number, an applicable product code such as UPC or ISBN, a manufacturer name, a product type or category, and the like.

Some examples of categories include airfares, hotels, rental cars, cruises, and vacation packages; comparative prices by retailer for a product or service by region and nation-wide including retailer reliability ratings; product reviews from partners such as Consumer Reports and/or online customers; product and service availability (regionally and nation-wide) with in stock data, and weeks to actual availability for out of stock items; product and service delivery options such as in store pickup with partners, or mail order delivery service; restaurants and eateries (regionally and nation-wide) including reviews, categorization by quality (stars), type (ethnic, convenience, etc.), or location (nearest or within a certain driving range), and the like.

In this example, CS application server 130 includes a search engine 410, an auction engine 420, and a billing engine 430. Search engine 410 includes hardware and/or software elements that retrieve information related to a product and/or service. Search engine 410 may connect to the Internet, and other third-party information retrieval services to retrieve information.

Auction engine 420 includes hardware and/or software elements that provide auction services to allow a user to place a bid, a counter bid, or allow the user to name their own price for a product and/or service. Auction engine 420 can connect to the Internet, and other third-party auction services to place a bid, obtain the status of a bid, and the like, and instruct voice portal 115 to generate one or more messages to the user indicating information related to the placement of the bid, status of the bid, acceptance of the bid, and the like.

In various embodiments, any time a user is offered a set of lowest price selections, system 100 may offer the opportunity to the user to name their own price, entering a negotiation or bidding process using auction partners such as Priceline, Hotwire, eBay, and other direct partners who offer bidding and/or price negotiation. In many “Name Your Own Price” schemes, there is a time delay in responding to the request. Accordingly, system 100 collects user data and preserves state for the duration of the bidding experience, calls the user back with the bid results.

Billing engine 530 includes hardware and/or software elements that provide for billing information associated with a user.

In one example of operation, CS application server 130 provides multi-modal responses to a user during the course of a phone call. For example, a caller with an enhanced phone that supports WAP browsing capabilities can receive images of products and web pages concerning a product and/or service. Multi-modal interaction can provide visual data to a caller to verify that the correct product is being offered or to provide visual information about a product or service.

In various embodiments, CS application server 130 provides transaction enabled information related to travel. For example, CS application server 130 may search for the lowest airfares available using available travel partners including, but not limited to: Orbitz, Expedia, Travelocity, Priceline, LowestFares.com, Sidestep, Hotwire, CheapAir, Kayak, CHEAPOAIR, Travelgrove, Farecast, CheapTickets, in addition to any direct partnerships with airlines that may occur. CS application server 130 may search for the lowest hotel prices available using the airfare travel partners in addition to hotels.com, venere.com, booking.com, and other potential partners.

CS application server 130, during an airfare search, may use the following user profile data, statistical assumptions for appropriate defaults, and information over-ridden by the user during the call to identify the number of stops (default non-stop), class (default coach), from or departure airport(s) (default based on airport proximity to caller E911 data), to or destination airport(s) (default to saved user data or user entry), travel dates (default to user entry), airline selection(s) (default to user preferences or all), number of travelers (default to 1 and inquire during billing for total number of tickets), and the like.

CS application server 130, during a hotel search, may use the following user profile data, statistical assumptions for appropriate defaults, and information over-ridden by the user during the call to identify class (default to 3 star hotels), proximity to airport/downtown or specific metro regions (default to downtown), specific desired amenities (default to none), airport transportation service (default to no value), and the like. In various embodiments, CS application server 130 updates the user's profile data.

CS application server 130, during a rental car search, may use the following user profile data, statistical assumptions for appropriate defaults, and information over-ridden by the user during the call to identify vehicle size/types (default based on number of airline tickets purchased), specific brands (default to user preferences from prior rentals), and the like.

In various embodiments, CS application server 130 provides transaction enabled information related to products and/or services. For example, CS application server 130 may search the Internet for the lowest prices available using product and/or services information partners, such as: Mysimon.com, ShopZilla.com, eBay.com (including shopping.com), Amazon.com, Overstock.com, pricescan.com, Shopping.MSN.com, Yahoo Shopping, marketworks.com.

CS application server 130, during a rental car search, may use the following user profile data, statistical assumptions for appropriate defaults, and information over-ridden by the user during the call to identify UPC or model name/number, product or service type, locale searches (default to nation-wide for online searches, regional based on caller E911 data for local pickup), and the like.

In some embodiments, CS application server 130, upon retrieving lowest prices data for a product, offers a caller information concerning the products, such as lowest prices, availability (quantity in stock), quickness of delivery (immediate local pickup vs. shipments), professional and consumer reviews, alternate offers that may not be best prices, but are immediately available for local pickup, and the like.

FIG. 5 is a block diagram of ADS application server 140 for providing advertisements in one embodiment according to the present invention. ADS application server 140 includes an advertising module 510.

Advertising module 510 includes hardware and/or software elements that provide targeted ads to a user. In various embodiments, advertising module 510 categorizes ad spots and deals based on specific keywords. When verbal input is received from the user that indicates a specific category of an ad spot ordeal, advertising module 510 may instruct voice portal 115 to generate one or more messages to the user indicating the particular ad spot ordeal. Advertising module 510 may also store text or e-mail coupons and deals that can be offered to the user via voice portal 115 at appropriate moments during the interaction of the user with voice portal 115.

In various embodiments, system 100 provides targeted voice recognition advertising. Typically, advertising on mobile devices utilize recordings played during phone calls, and images and banners displayed on WAP browsers. These advertisements are essentially static, small, and unreadable, and not usually well targeted towards the mobile user.

To provide targeted voice recognition advertising, in one example, system 100 matches advertisements to specific text. System 100 matches different advertisements to spoken utterances of the user using voice recognition. In some embodiments, a like, different, or associated ads, special offer, coupon, etc. may be displayed to the user of laptop computer 102 or mobile device 104 that may differ from the audio being hear by the user.

In some embodiments, system 100 matches advertisements to spoken utterances of a user detected during a phone call using voice recognition. In these various embodiments, system 100 generates advertising messages that include audio received on the call, and numerous forms of multi-modal advertising that allow the user to receive advertisements displayed directly on the laptop computer 102 or the mobile device 104 in various formats without interrupting the current call in process. System 100 may provide these advertising messages via audio, static and animated images, streaming video, SMS (text messages), MMS (multi-media messages that can include images, video, audio, and text), and WAP (internet pages that can display any data available to web services), as well as other advertising formats.

In various embodiments, system 100 allows a user to accept an advertisement offer during a call, for example, using voice recognition or navigation keys on mobile device 104, and be connected with the advertiser for fulfillment without disrupting the original call. System 100 may further provide a user with advertisements that remain on laptop computer 102 or mobile device 104, and can be used as coupons or responded to at will by the user. In some embodiments, system 100 provides advertisements that contain actual specific special offers, deals, instant rebate certificates, coupons, or offer simple brand recognition and/or product and service awareness as well as other forms.

In one embodiment, an advertising manager may instruct system 100 to directly match specific advertising to specific spoken utterances, without extensive analysis. In another embodiment, system 100 provides a specific spoken utterance that is associated with multiple types of advertising matched against it. For example, if the spoken utterance is “United Airlines,” system 100 may select a United Airlines advertisement, or system 100 may select an advertisement from a competitor of United Airlines, or system 100 may generate general advertisements related to travel to be conveyed to the user. In one embodiment, in response to a user uttering “United Airlines,” system 100 generates and conveys a displayable ad to mobile device 104 related to a competitor of United Airlines, while system 100 generates and conveys a dialog on the ear piece of mobile device 104 that may differ from the displayable ad related to the competitor of United Airlines.

In other words, system 100 may generate an ad to be sent to the display of mobile device 104 that does not match the audio being heard by the user of mobile device 104. The user of mobile device 104 may continue to speak or listen to the original call, but display of mobile device 104 is showing an ad, special offer, coupon for product or service and the like, that may be closely associated with the conversation, keywords and/or phrases. For example, a user of laptop computer 102 places a call through system 100 to request directory assistance for United Airlines. System 100 prompts the user by querying the user as to whether the user would like help finding the lowest fare. If the user responds, “yes,” system 100 begins the itinerary creation process: “What is your departure date?” While the user is creating an itinerary via audio, system 100 generates and conveys visual data (i.e., ads, coupons, special offers, etc.) that are from United Airlines, a competitor of United Airlines, a symbiotic related sponsor, and the like.

In one embodiment, system 100 includes a rules engine. Using rule based analysis, system 100 selects from multiple potential matched advertisements to determine the highest value proposition for a user and for an advertiser based on known or discovered data concerning the user and known or discovered data from the potential matching advertisements and dynamic data provided by advertisers. In one example, system 100 use variable weightings assigned to know or discovered data to assist system 100 in determining and selecting advertisements that provide the desired value proposition to each advertiser, user of the system, channel partners, etc.

Known or discovered data concerning a user includes, but is not limited to, caller id (to identify the caller), location based data (where they are calling from), a collection of spoken utterances matched using voice recognition, user responses to inquiries from the invention, spoken or saved user preferences and interests, previously archived data about the caller such as transactions processed through the system and prior accepted and rejected advertisement offers and other potential discoverable caller data, and the like. Known or discovered data concerning an advertiser or advertisements includes, but is not limited to, inventory checks, supply/demand analysis, advertisement weightings which can be increased by amount spent, ad exposure analysis, and other potential discoverable advertiser data, and the like.

In one example, a caller requests United Airlines. System 100 having known or unknown data about the caller (i.e., the caller belongs to the United Mileage Plus program) has created an itinerary from San Francisco, Calif. to Seattle, Wash. System 100 then navigates through various databases and/or partnership sites, and determines that the caller may not have an affinity program with American Airline. Therefore, offing 5000 additional air miles on American Airlines to this caller is of very little value. System 100 then may determine, for example, inventory levels of American Airline's flights from San Francisco to Seattle, and may generate and convey a message indicating an offer for a free friends fly free ticket for the same price as United Airlines (i.e., if the caller signs up for American Airlines mileage program). In effect, system 100 analyzes the caller's responses and redirects the caller in some cases to other locations then the caller's first intention by providing value propositions in the form of coupons, special offers, advertisements, and the like.

In some embodiments, system 100 monitors dialog during a call made by a user. System 100 then may generate and convey ads to the user based on the conversation of the call. The user can approve and accept free offers, advertisement, coupons, and the like, based on conversations taking place in real time.

FIG. 6 is a block diagram of PIM application server 145 for providing personal information management in one embodiment according to the present invention. In general, PIM application server 145 provides a Unified Messaging Center (UMC) offering IVR enabled access to voice mail, and TTS rendering of e-mail and TXT messages. PIM application server 145 allows a caller to send voice mail, e-mail, and TXT messages using IVR dictation technology to any user with an e-mail address (e-mail), a phone number (TXT messages), or an in-system phone number (voice, TXT, and e-mail).

PIM application server 145 includes a contact module 610 and a calendar module 620. Contact module 610 includes hardware and/or software that allow a user to store contact information, and to initiate calls to a contact based on the stored contact information. For example, contact module 610 may offer an online contact list that is IVR enabled so that the user can use it for voice dialing. PIM application server 145 further allows the user the ability to add, edit, and delete contacts from the contact list.

Calendar module 620 includes hardware and/or software components that provide a configurable calendar for scheduling events. Notifications and/or alerts may be associated with events scheduled in the user's calendar. These alerts may be received by the user through a phone call via voice portal 115, or via e-mail and text messages sent to a device associated with the user.

In various embodiments, calendar module 620 receives information from a user to generate a configurable alarm by setting, editing, and deleting reminders and alerts using IVR. The user may set the configurable alarm to generate an alert one week ahead, one day ahead, 90 minutes ahead, or any other user configurable time. Calendar module 620 may also obtain weather information, location information, traffic related information, emergency or disaster related information, to set or adjust alarms previously configured by the user. For example, calendar module 620 may obtain the current flight status of an airplane on which a user is scheduled to depart. If the current flight status indicates that the airplane is going to be delayed, calendar module 620 may generate an alert to the user indicating the delay of the airplane, and allow the user to update or reset a configurable alarm to take into account the delay of the airplane.

In some embodiments, calendar module 620 provides additional travel related services, such as automatic calendar/alert service to remind a caller of a reservation (airline, restaurant, or hotel) via callback, TXT, e-mail, or MMS, alert services providing a call to execute reservation confirmations and/or early check-ins for air travel, picking up boarding passes at the airport, 3rd party alert for automatic notifications of delayed flights, weather alerts, and riving directions via an interactive callback, TXT messages, e-mail, or MMS for destinations such as local stores, the airport, or the hotel in a destination city after arrival at the destination, and the like.

FIG. 7 is a block diagram of UPS application server 150 for providing user profiling in one embodiment according to the present invention. UPS application server 150 includes a user profiling module 710.

User profiling module 710 includes hardware and/or software elements that save information related to a user in profile data associated with the user. For example user profiling module 710 may save information related to transactions consummated by the user with system 100, such as billing information, shipping information, financial information, information for third-party sites for which the user has an individual account, and the like. User profiling module 710 may also provide the user with the ability to update stored user profile data.

In general, UPS application server 150 stores a user's profile data and is used by various components of System 100 to enhance the shopping experience of the user. The profile data stored for each user may provide hints and information for system 100 to interact with the user and provide highly qualified targeted information and advertisements.

In various embodiments, UPS application server 150 acts as a data store for system 100 to store user data and search history, pertinent usage and search data about each call from the same number, data concerning transactions, including products or services purchased, and billing information, data such as alerts, calendaring operations, and even listings called to further customize user data, reverse lookups to determine and identify the caller, and E911, cellular, and GPS location information.

FIG. 8 is a block diagram of LBS application server 155 for providing location-based services in one embodiment according to the present invention. LBS application server 155 includes an E911 module 810 and a driving directions module 820.

The E911 module 810 includes hardware and/or software elements that provide location-based information associated with the user. For example, E911 module 810 may provide E911 location information, GPS location information, cellular location information, and the like.

Driving directions module 820 includes hardware and/or software elements that receive at least one location to provide driving directions. The driving directions may be obtained from location information partners, or directly from the Internet. The driving directions may further include the location information associated with the user to provide up-to-date and real time driving directions.

FIG. 9 is a block diagram of DA application server 160 for providing directory assistance services in one embodiment according to the present invention. VA application server 160 includes a director re assistance module 910. Directory assistance module 910 includes hardware and/or software elements that retrieve directory listings for a user. Directory assistance module 910 may instruct voice portal 915 to generate one or more messages to the user indicating the directory listing.

In general, DA application server 160 provides the full functionality of industry standard 411-directory assistance utilizing voice enabled user interfaces, for example, by directly connecting users to a listing. In various embodiments, DA application server 160 retrieves directory listings via ASR, and utilizes high quality TTS where recorded voice is not available. DA application server 160 may provide the user the option to receive a 411 listing or a cellular telephone listing via voice, TXT message, SMS/MMS message, or e-mail. In some embodiments, DA application server 160 routes calls to a live agent for assistance. In various embodiments, DA application server 160 retrieves listings that can be accompanied by a targeted advertisement as voice, TXT, e-mail, or an MMS message.

In some embodiments, DA application server 160 performs reverse lookups of a caller by using UPS application server 150 and LBS application server 155. Multiple listings may be retrieved by category or close search matches for caller selection of listing. While performing listing lookups, DA application server 160 may search in the user's profile data for saved listings before searching in directory assistance databases.

In various embodiments, accepting an offer to participate in the comparison shopping experience will cause the user (or the user's call) to leave the DA application server 160, thus, the state of the call is saved in the user's profile data so that the user can always return to their initial starting point seamlessly.

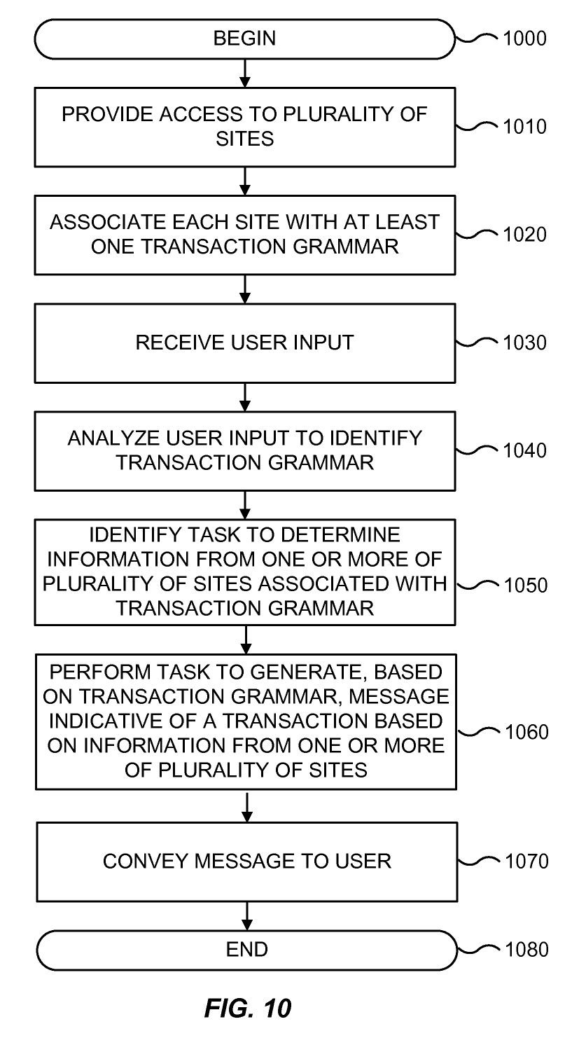

FIG. 10 is a simplified flowchart for providing transaction-enabled information in one embodiment according to the present invention. The processing depicted in FIG. 10 may be performed by software modules (e.g., instructions or code) executed by a processor of a computer system, by hardware modules of the computer system, or combinations thereof. FIG. 10 begins in step 1000.

In step 1010, system 100 provides access to a plurality of sites. In step 1020 system 100 associates each of the plurality of sites with at least one transaction grammar. A transaction grammar may be associated with categories that include terms such as: airline(s), airfare, trip, travel, hotel, motel, non-stop, cheapest fare, rental car, 4 star, 3 star, etc.; all major commercial airline names: Continental, United Airlines, SouthWest, Jet Blue, American Airlines, Alaska Air, etc.; all major commercial hotel chain names: Marriot, Hilton, Sheraton, Travel Lodge, Motel 6, etc.; all major commercial rental car agencies: Hertz, Avis, Budget, Dollar, etc.; major commercial big box consumer electronics retailers: Best Buy, Toys R Us, Circuit City, Fry's Electronics, etc.; restaurants by name and categories such as by quality and classification: (ethnic: Italian, Indian, Chinese, etc.), fine dining, café, etc., and the like.

In step 1030, system 100 receives user input. In step 1040, system 100 analyzes the user input to identify a transaction grammar. For example, if system 100 receives textual input or verbal input from a user indicative of “United Airlines,” system 100 may identify a transaction grammar that defines one or more messages related to travel information.

In step 1050, system 100 identifies a task to determine information from one or more of the plurality of sites associated with the transaction grammar. For example, system 100 may determine the lowest priced fares to various destinations currently offered by United Airlines. In step 1060, system 100 performs the task to generate, based on the transaction grammar, a message indicative of a transaction based on the information from the one or more of the plurality of sites.

In step 1070, system 100 conveys the message indicative of the transaction to the user. For example, system 100 may audibly convey the message to the user via mobile device 104. In another example, system 100 may generated a text, SMS, or MMS message to be sent to mobile device 104. In yet another example, system 100 may generate a multimedia document to be displayed on laptop computer 102. FIG. 10 ends in step 1080.

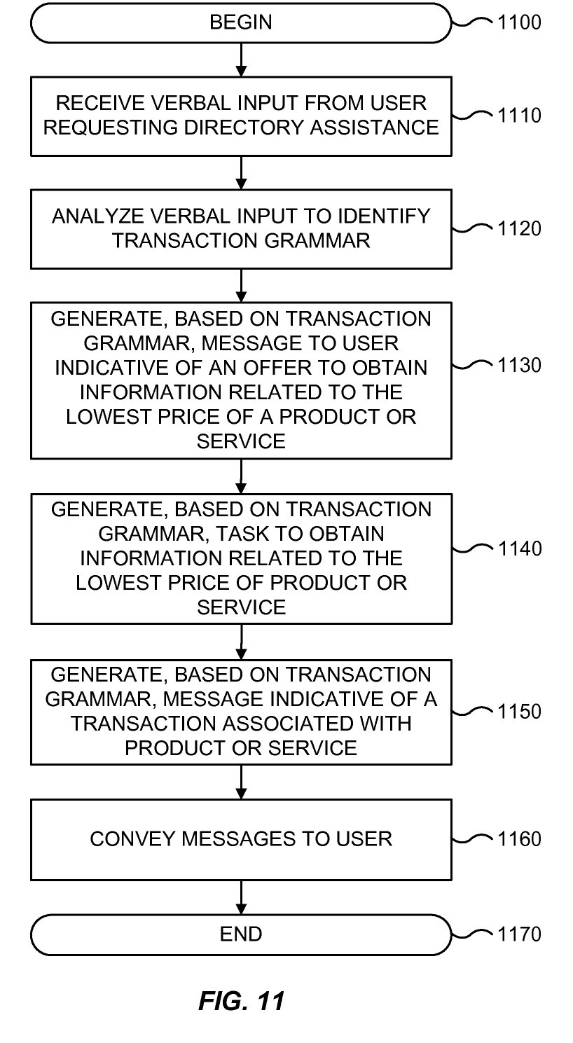

FIG. 11 is a simplified flowchart for providing interactive 411 directory assistance in one embodiment according to the present invention. The processing depicted in FIG. 11 may be performed by software modules (e.g., instructions or code) executed by a processor of a computer system, by hardware modules of the computer system, or combinations thereof. FIG. 11 begins in step 1100.

In step 1110, system 100 receives verbal input from a user requesting directory assistance. In step 1120, system 100 analyzes the verbal input to identify a transaction grammar.

In step 1130, system 100 generates, based on the transaction grammar, a message to the user indicative of an offer to obtain information related to the lowest price of a product or service. In step 1140, system 100 generates, based on the transaction grammar, a task to obtain information related to the lowest price of the product or service. In step 1150, system 10 generates, based on the transaction grammar, a message indicative of a transaction associated with the product or service.

For example, system 100 may offer to find the lowest priced airfares to various destinations offered by United Airlines. System 100 then may search travel sites on the Internet to obtain information related to the various destinations and the airfares offered by United Airlines. System 100 then may audibly convey to the user the lowest priced airfares, and offer to allow the user to purchase one or more of the airfares. FIG. 11 ends in step 1150.

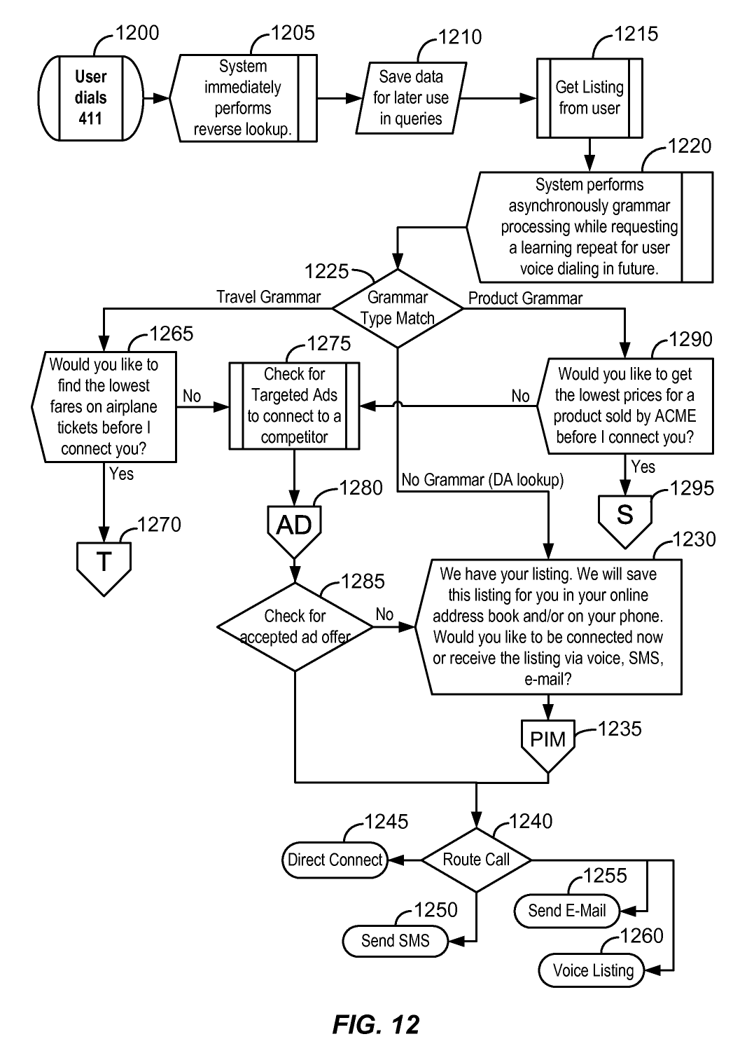

FIG. 12 is a flowchart for providing transaction-enabled directory assistance information in one embodiment according to the present invention. FIG. 12 begins in step 1200 were a user dials 411 for directory assistance. In step 1205, system 100 performs a reverse lookup on the user to determine user information, such as telephone number, IP address, location, and the like. In step 1210, system 100 saves the user information for later use (e.g., in user profile data).

In step 1215, system 100 generates a message to the user indicating a request to obtain a listing from the user. For example, system 100 generates a message indicating “What listing please?” In step 2220, system 100 receives verbal input from the user indicating a listing. In one example, a user provides verbal input indicating “United Airlines.” System 100 performs asynchronous grammar processing on the verbal input received from the user. While system 100 determines a transaction grammar in step 1225, system 100 may further request a learning repeat from the user to provide future voice dialing features. For example, system 100 may generate a message to the user indicating “Please repeat the listing, so that a voice record may be created for future voice dialing.”

In step 1225, system 100 determines a transaction grammar that matches one or more keywords associated with the verbal input received from the user. If no transaction grammar is identified, in step 1230, system 100 generates a message to the user indicating information associated with the listing, and at least one task or transaction. For example, system “We have your listing. We will save this listing for you in your online address book and/or on your phone. Would you like to be connected now, or receive the listing via voice, SMS, or e-mail?”

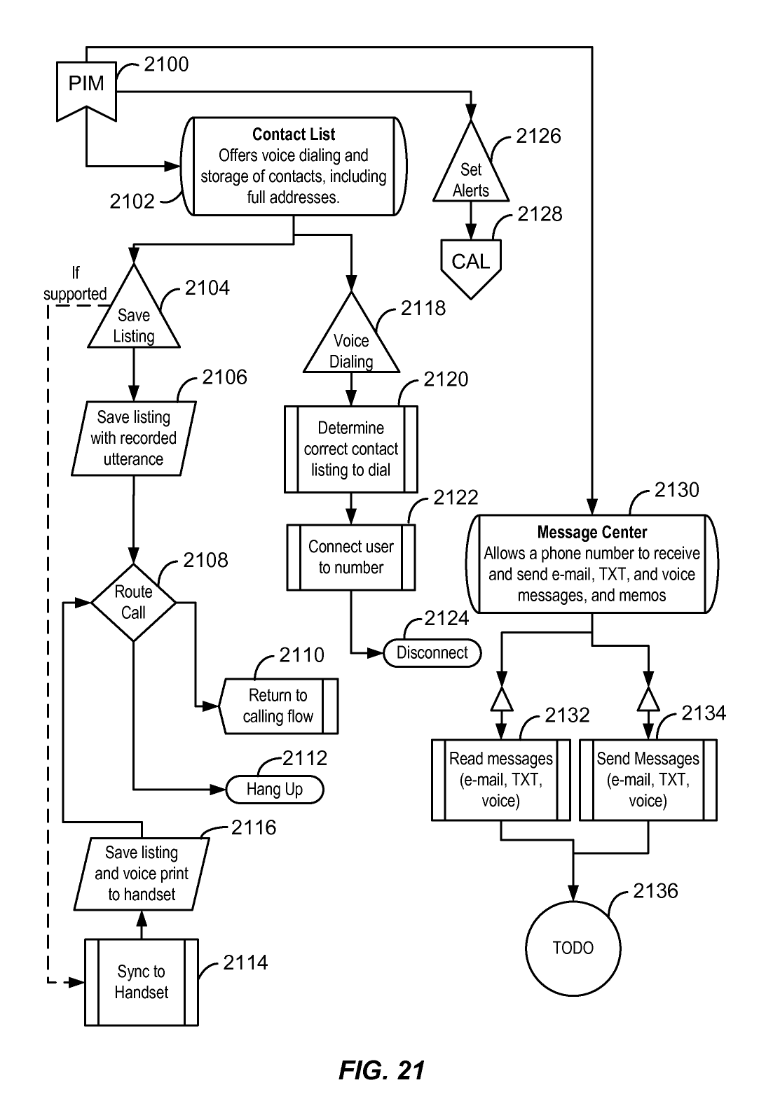

In step 1235, system 100 generates one or more messages to the user to obtain from the user a mechanism and format for sending the listing to the user. One example of processing in step 1235 by system 100 is depicted in FIG. 21.

In step 1240, system 100 routes the user's call based on verbal input from the user. If system 100 receives verbal input from the user indicating that the user wishes to be connected directly to the listing, in step 1245, system 100 connects the user to the listing. If system 100 receives verbal input from the user indicating that the user wishes to be sent the listing via SMS, in step 1250, system 100 sends the user the listing via SMS (e.g., through PIM application server 145). If system 100 receives verbal input from the user indicating that the user wishes to be sent the listing via an e-mail, in step 1255, system 100 sends the user the listing via e-mail (e.g., through PIM application server 145). If system 100 receives verbal input from the user indicating that the user wishes to receive the listing via a voice recording, in step 1260, system 100 sends generates a voice message to the user that includes information associated with the listing (e.g., via voice portal 115).

Alternatively, in step 1225, if system 100 determines a transaction grammar that matches one or more travel keywords associated with the “United Airlines” verbal input provided by the user, system 100 generates a message to the user indicating a transaction based on the travel transaction grammar. For example, system 100 may generate a message to the user indicating “Would you like to find the lowest fares on airline to airplane tickets before I connect you?”

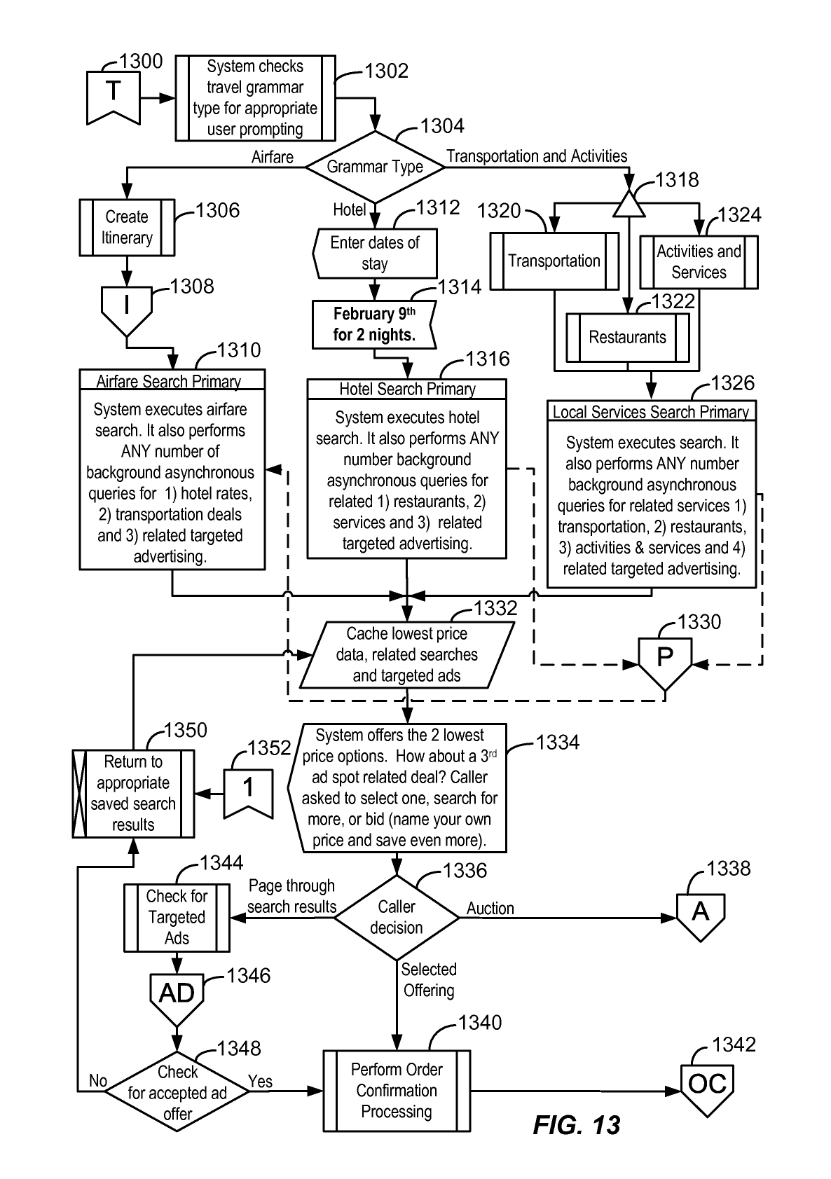

If system 100 receives verbal input from the user indicating that the user wishes to find the lowest fares, in step 1270, system 100 generates one or more messages to the user to interact with the user to find the lowest travel fares. One example of processing in step 1270 by system 100 is depicted in FIG. 13. If system 100 receives verbal input from the user indicating that the user does not wish to find the lowest fares, in step 1275, system 100 checks for targeted ads to connect to a competitor.

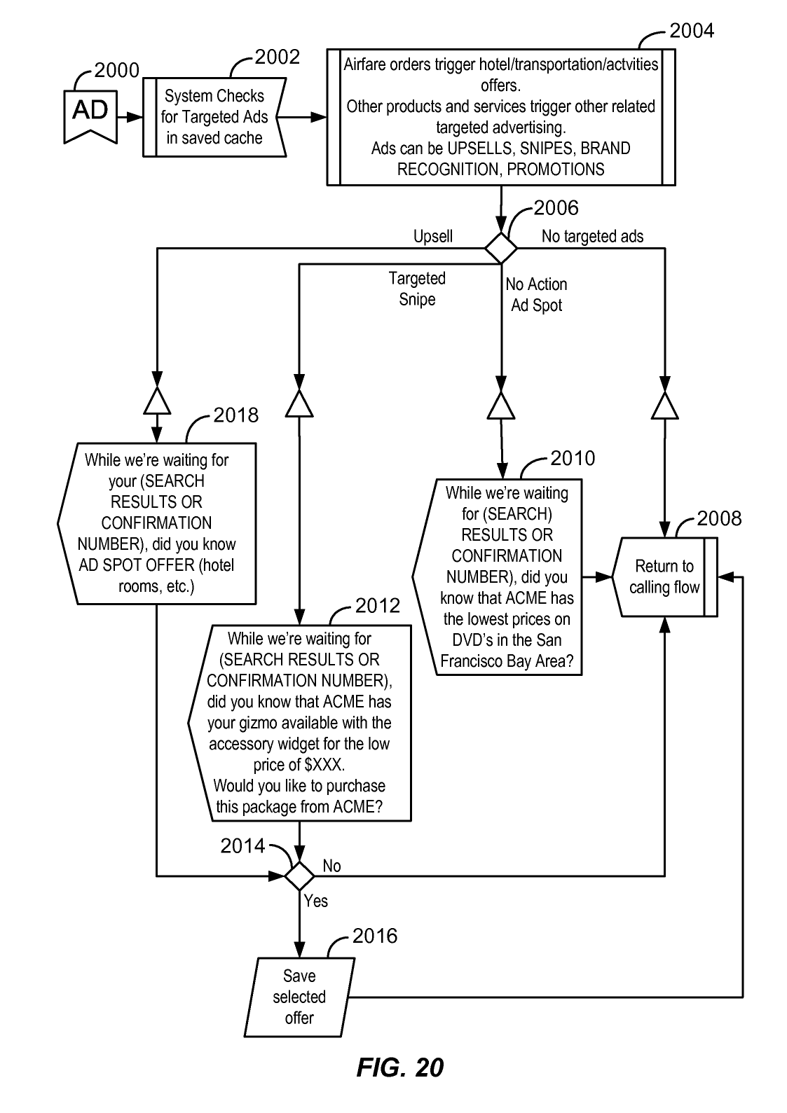

In step 1280, system 100 generates one or more messages to the user indicating targeted ads. One example of processing in step 1280 by system 100 is depicted in FIG. 20. If system 100 receives verbal input from the user indicating that an offer in a targeted ad, in step 1285, system 100 routes the user's call based on verbal input from the user. For example, in step 1245, system 100 connects the user to the telephone number of the competitor identified in the targeted ad accepted by the user. If system 100 receives verbal input from the user indicating that the offer in the targeted ad is not accepted by the user, system 100 returns to call processing in step 1230.

If system 100 determines a transaction grammar in step 1225 that matches one or more product and/or services keywords associated with the “United Airlines” verbal input provided by the user, system 100 generates a message to the user indicating a transaction based on the product ad/or service transaction grammar. For example, system 100 may generate a message to the user indicating “Would you like to get the lowest prices for a product and/or service sold by ACME before I connect you?”

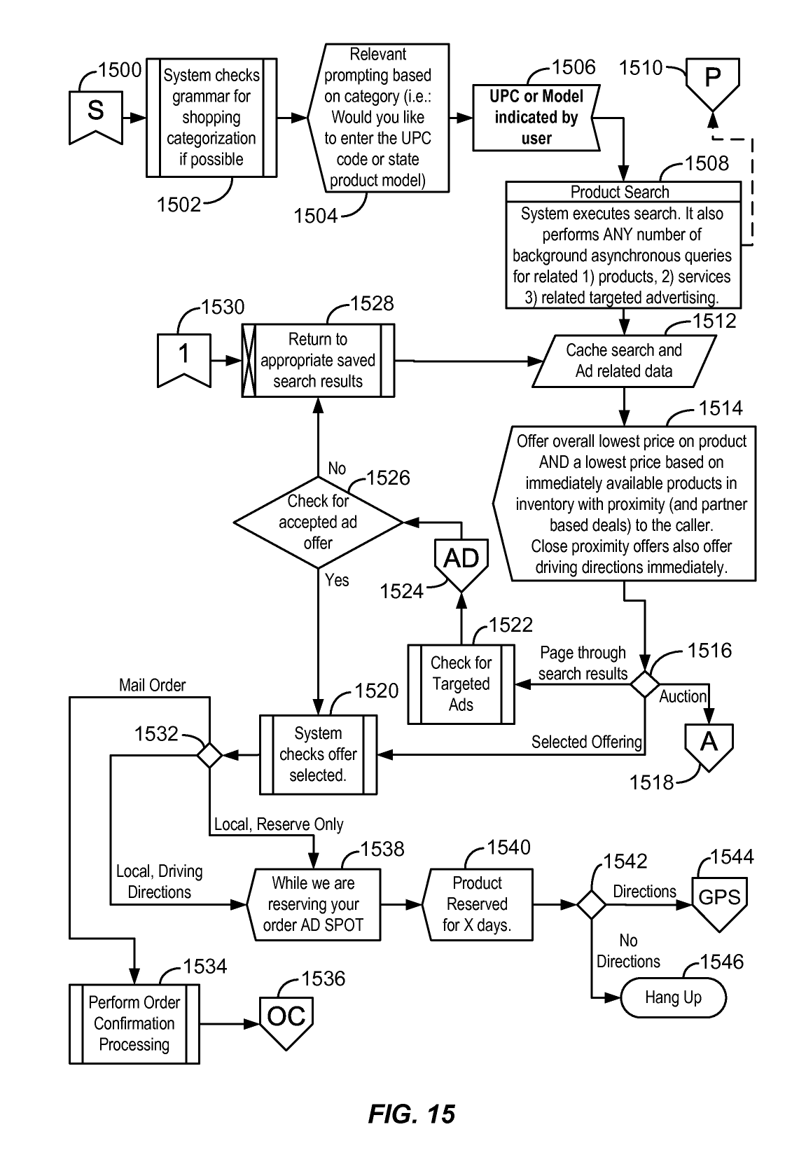

If system 100 receives verbal input from the user indicating that the user does not wish to find the lowest product price, system 100 checks for targeted ads in step 1275. If system 100 receives verbal input from the user indicating that the user wished to find the lowest product price, in step 1295, system 100 generates one or more messages to the user to interact with the user to find the lowest price for a product and/or service. One example of processing in step 1295 by system 100 is depicted in FIG. 15.

FIG. 13 is a flowchart for providing transaction-enabled comparison shopping travel information in one embodiment according to the present invention. FIG. 13 begins in step 1300.

In step 1302, system 100 determines an appropriate transaction grammar or transaction grammars in order to generate one or more messages to the user to interact with the user to obtain information related to travel. For example, if the user is looking for “United Airlines,” system 100 determines that the user is looking for airfare and selects a transaction grammar associated with airfare. In another example, system 100 selects a transaction grammar associated with hotels to compliment the transaction grammar associated with airfare.

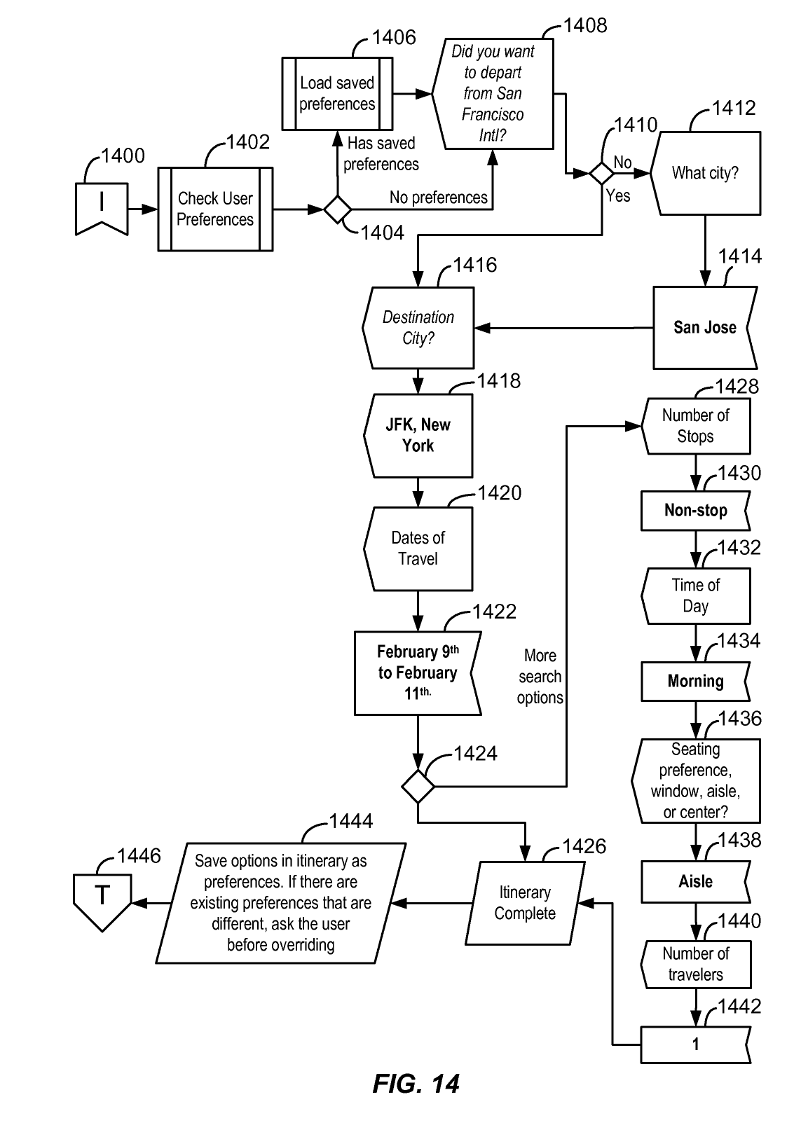

In step 1304, based on the determined one or more transaction grammars, system 100 interacts with the user to obtain travel information. If system 100 selects a transaction grammar associated with airfare, in step 1306, system 100 creates an itinerary. In step 1308, system 100 generates one or more messages to the user to interact with the user to build the itinerary. One example of processing in step 1308 by system 100 is depicted in FIG. 14. In step 1310, system 100 executes an airfare search based on the itinerary. System 100 may also perform any number of background asynchronous queries to determine hotel rates, transportation deals, and related targeted advertising to generate one or more messages to the user indicative of the hotel rates, transportation deals, and related targeted advertising.

Alternatively, if system 100 selects a transaction grammar associated with hotels in step 1312, system 100 generates a message to the user indicating booking information. For example, system 100 may generate a message to the user indicating “Please say the dates of for your stay?” In step 1314, system 100 receives verbal input from the user indicating the booking information. For example, a user may provide verbal input indicating “February 9 for 2 nights.” In step 1316, system 100 executes a hotel search based on the booking information. System 100 may also perform any number of background asynchronous queries to determine restaurants, related services, and related targeted advertising to generate one or more messages to the user indicative of the restaurants, related services, and related targeted advertising.

Alternatively, if system 100 selects a transaction grammar associated with transportation and activities, in step 1318, system 100 further determines additional or sub-category transaction grammars associated with transportation and activities. For example, in step 1320, system 100 generates a message to the user indicative of information related to transportation. In step 1322, system 100 generates a message to the user indicative of information related to restaurants. In step 1324, system 100 generates a message to the user indicative of information related to activities and services.

In step 1326, system 100 executes a search based on verbal input received from the user related to the transportation information, the restaurant information, and/or the information related to activities and services. System 100 may also perform any number of background asynchronous queries for related services associated with transportation, restaurants, activities and services, and related targeted advertising to generate one or more messages to the user indicative of the transportation, restaurants, activities and services, and related targeted advertising.

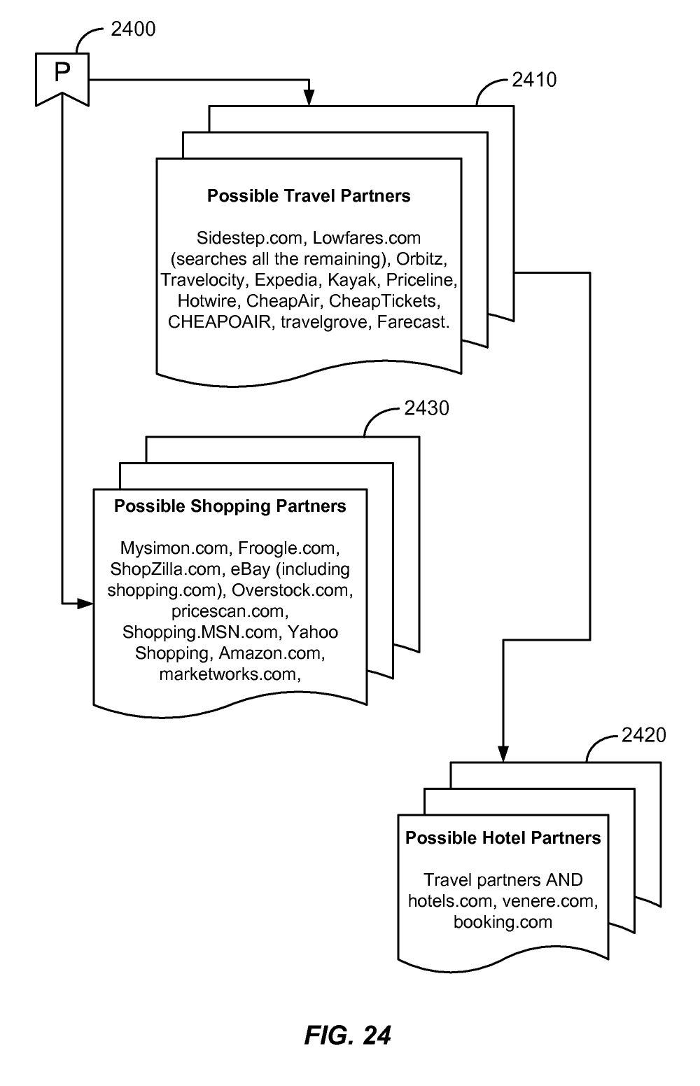

In some embodiments, system 100 may transfer the user in steps 1310, 1316, and 1326, to one or more information partners. In step 1330, the one or more information partners interact with the user to initiate or consummate transactions related to travel. One example of processing in step 1330 is depicted in FIG. 24.

Returning to FIG. 13, in step 1332, system 100 caches the information, such as the lowest price data, related searches, and targeted ads, determined in steps 1310, 1316, and 1326. In step 1334, system 100 generates a message to the user indicative of the information obtained through the searches in steps 1310, 1316, and 1326. For example, system 100 may generate a message indicating the two lowest priced options for the airfare search, the hotel search, and/or the transportation and activity search. System 100 may also generate a message indicative of a targeted ad related to be airfare search, the hotel search, and/or the transportation and activity search. System 100 may generate a message indicating to the user to select one of the options, to search for more options, or to bid on one of the options.

System 100 may generate a message indicating to the user to name your own price as an alternative to bidding on one or more options.

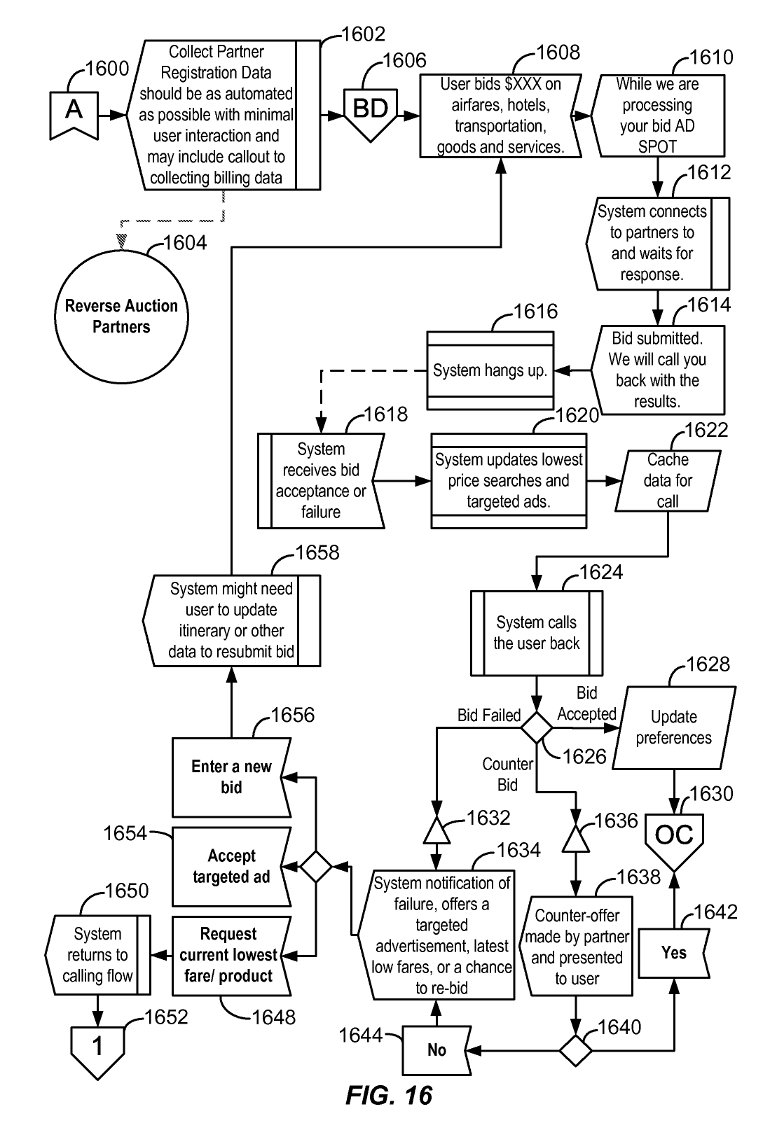

In step 1336, based on verbal input from the user, system 100 determines how to route the user's call based on the information obtained through the searches in steps 1310, 1316, and 1326. If system 100 receives verbal input from the user indicative of an auction, in step 1338, system 100 generates one or more messages to the user to interact with the user to provide auction services. One example of processing in step 1338 by system 100 is depicted in FIG. 16.

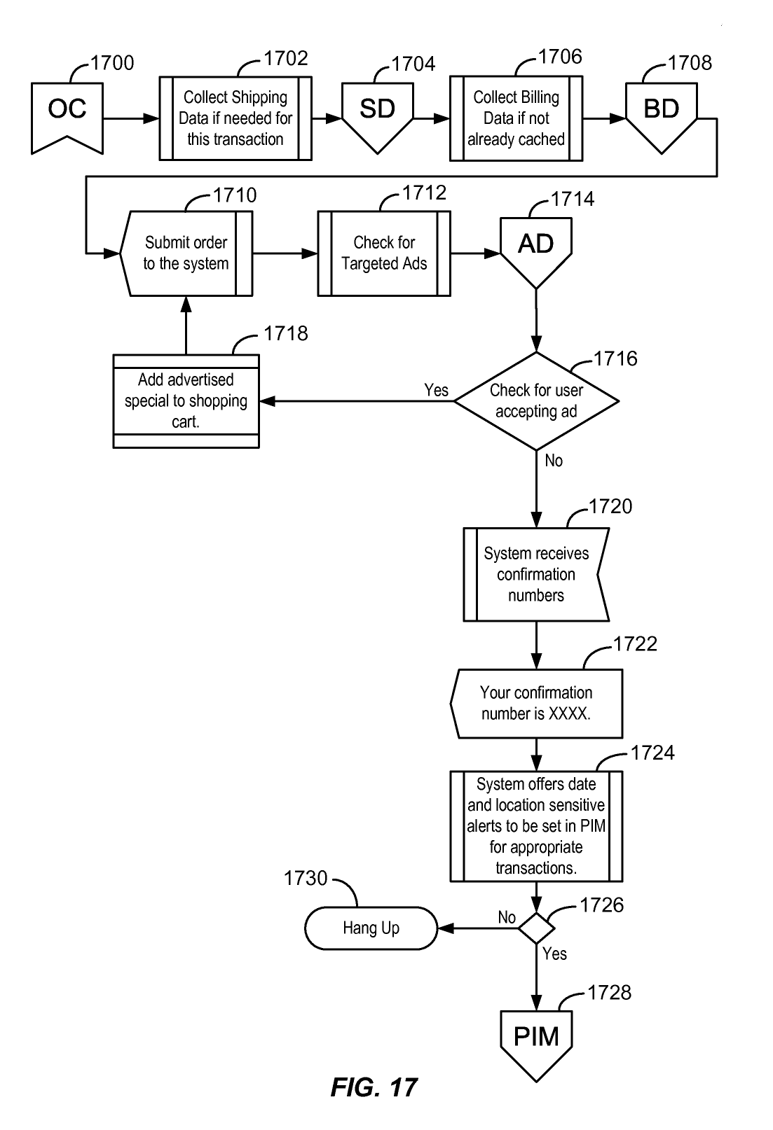

If system 100 receives verbal input from the user indicating that the user wishes to purchase one of the two lowest priced options, in step 1340, system 100 performs order confirmation processing for the option. In step 1342, system 100 generates one or more messages to the user to interact with the user to confirm the order. One example of processing in step 1342 by system 100 is depicted in FIG. 17.

If system 100 receives verbal input from the user indicating that the user wishes to search for more options that the two lowest priced options, in step 1344, system 100 checks for one or more targeted ads related to the information obtained through the searches in steps 1310, 1316, and 1326. In step 1346, system 100 generates one or more messages to the user indicating targeted ads. If, in step 1348, system 100 receives verbal input from the user indicating that the user accepts an offer in one of the targeted ad, in step 1340, system 100 performs order confirmation processing.

If, in step 1348, system 100 receives verbal input from the user indicating that the user does not accept an offer in any of the targeted ad, in step 1350, system 100 returns to the appropriate save search results to obtain further information. System 100 then returns in step 1332 to cash the lowest price data, related searches, and targeted ads, which are then again presented to the user in step 1334.

As shown in FIG. 13, at certain times during the interaction of the user with system 100, system 100 may return in step 1352 to the appropriate saved search results in step 1332 to obtain further information.

FIG. 14 is a flowchart for providing transaction-enabled comparison shopping information related to travel itineraries in one embodiment according to the present invention. FIG. 14 begins in step 1400.

In step 1402, system 100 checks for user preferences. In step 1404, if system 100 identifies user preferences (e.g., from user profile data that the user has saved preferences before), in step 1406, system 100 loads the saved preferences for the user. For example, the user may have saved the user's city of residence as “San Francisco.” In step 1408, system 100 generates a message to the user indicating whether the user wishes to user identified user preferences. For example, system 100 may generate a message to the user indicating “Did you want to depart from San Francisco international?”

If, in step 1404, system 100 does not identify any user preferences, system 100 may use caller ID, reverse lookup, or other location-based information to generate the message in step 1408.

If, in step 1410, system 100 receives verbal input from the user indicating that the user does not wish to depart from a location saved in the user's preferences, in step 1412, system 100 generates a message to the user indicating a request for a city of departure. In step 1414, system 100 receives verbal input from the user indicating a city of departure. For example, a user may provide verbal input indicative of “San Jose.”

If, in step 1410, the user wishes to depart from the location saved in the user's preferences, or, in step 1414, the user provides a city of departure, in step 1416, system 100 generates a message to the user indicating a request for a destination city. In step 1418, system 100 receives verbal input from the user indicating a destination city. For example, a user may provide verbal input indicating “JFK, New York.”

In step 1420, system 100 generates a message to the user indicting a request for travel dates. In step 1422, system 100 receives verbal input from the user indicating one or more travel dates. For example, a user may provide verbal input indicating the travel dates as “February 9 to February 11.”

In step 1420, system 100 generates a message to the user indicating whether the user wishes to request more search options. If system 100 receives verbal input from the user indicating that the user does not wish to provide more search options, in step 1426, system 100 completes the itinerary between the departure city and the destination city.

If system 100 receives verbal input from the user indicating that the user wishes to provide more search options, in step 1428, system 100 generates a message to the user indicating a request for the number of stops. In step 1430, system 100 receives verbal input from the user indicating the number of stops. For example, a user may provide verbal input indicating the number of stops as “non-stop.”

In step 1432, system 100 generates a message to the user indicating the time of day that the user wishes to depart or arrive. In step 1434, system 100 receives verbal input from the user indicating the time of day. For example, a user may provide verbal input indicating the time of day as “Morning.” In step 1436, system 100 generates a message to the user indicating whether the user has a seating preference, such as window, aisle, or center. In step 1438, system 100 receives verbal input from the user indicating a seating preference. For example, a user may provide verbal input indicating the seating preference as “aisle.” In step 1440, system 100 generates a message to the user indicating a request for the number of travelers. In step 1442, system 100 receives verbal input from the user indicating a number of travelers. For example, a user may provide verbal input indicating the number of travelers as “one.” System 100 then completes the itinerary between the departure city and the destination city in step 1426 using the search options.

In step 1444 system 100 saves the search options in the itinerary as preferences. If there are existing preferences that are different, system 100 may generate a message to the user indicating a request for confirmation from the user before overwriting existing preferences. In step 1446, system 100 generates one or more message to the user to interact with the user to complete purchase of the travel itinerary (e.g., step 1310 of FIG. 13).

FIG. 15 is a flowchart for providing transaction-enabled comparison shopping information related to products and/or services in one embodiment according to the present invention. FIG. 15 begins in step 1500.

In step 1502, system 100 determines a transaction grammar associated with shopping categories. In step 1504, system 100 generates a message to the user prompting the user based on the transaction grammar associated with the shopping categories. For example, system 100 may prompt the user to enter a UPC code or state a product model.

In step 1506, system 100 receives verbal input from the user based on the message. For example, a user may provide verbal input indicating a UPC or model of a product.

In step 1508, system 100 executes a search for a product and/or service based on the information provided by the user. System 100 may also perform any number of background asynchronous queries for related products, services, and related targeted advertising. Alternatively, in step 1510, system 100 may transfer the user to one or more partners.

In step 1512, system 100 caches the product search data and related target advertising. In step 1514, system 100 generates a message to the user indicating the overall lowest price of the product and/or service. System 100 may also generate a message to the user indicating the lowest price based upon immediate availability of the product in inventory with proximity to the user. System 100 may also generate a message to the user indicating driving directions to the location having the product in inventory with proximity to use.

In step 1516, system 100 receives verbal input from the user indicating whether to place a bid on the project, to select one or more of the offerings, or to search for more information related to the product. If, in step 1516, system 100 receives verbal input from the user indicating an auction, in step 1518, system 100 generates one or more messages to the user to interact with the user to initiation an auction (e.g., FIG. 16). If, in step 1516, system 100 receives verbal input from the user indicating selection of one of the two lowest priced offers, in step 1520, system 100 checks the offer that was selected by the user.

If, in step 1516, system 100 receives verbal input from the user indicating to search for more information related to the product search of step 1508, in step 1522, system 100 checks for targeted ads related to the product search. In step 1524, system 100 generates one or more messages to the user indicative of targeted ads (e.g., FIG. 16). In step 1526, system 100 determines whether an offer associated with the targeted ads has been accepted by the user. If yes, in step 1520, system 100 checks the offer that was selected by the user. If no, in step 1528, system 100 returns to the appropriate save search results.

As shown in FIG. 15, at certain times during the interaction of the user with system 100, in step 1530, system 100 returns call processing to the appropriate saved search results in step 1528.

Returning to FIG. 15, in step 1532, system 100 determines whether the offer selected by the user was for mail order, local pickup with driving directions, or local pickup with reserve only. If system 100 determines that the offer was for mail order, in step 1534 system 100 performs order confirmation process in step 1536. If system 100 determines that the offer was for local pickup with driving directions, in step 1538 the system generates a message indicating that the product is being reserved. System 100 may also, while reserving the product, generate one or more messages to the user indicative of targeted ads. If system 100 determines that the offer was for local pickup with reserve only, in step 1538, system 100 again generates a message indicating that the product is being reserved.

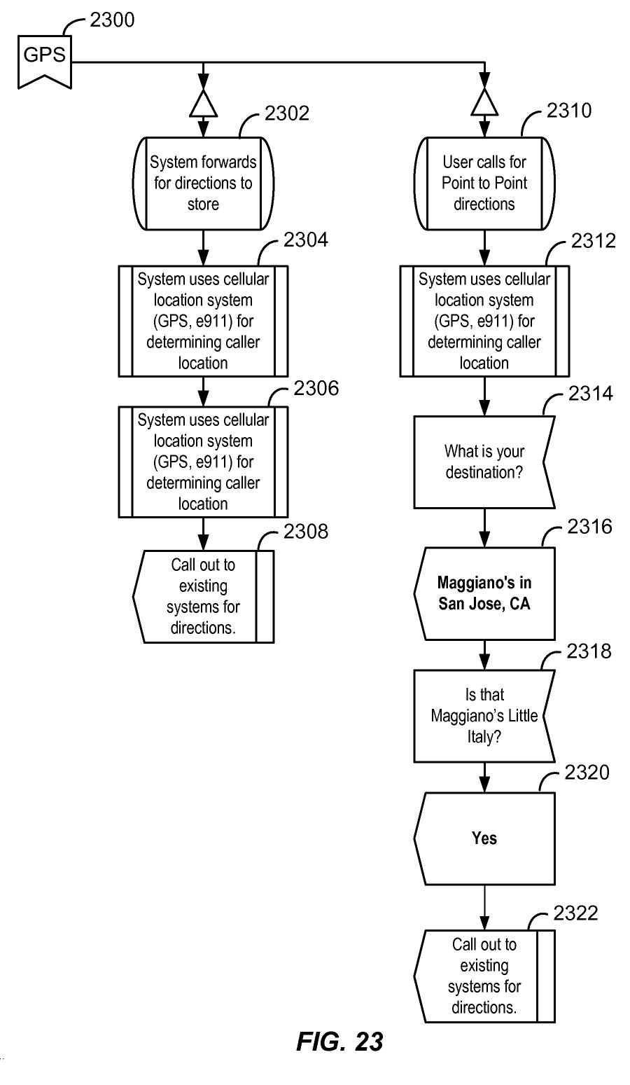

In step 1540, system 100 generates a message to the user indicating that the product has been reserved for a predetermined number of days. In step 1542, if the user requested local pickup with driving directions, in step 1544, system 100 generates a message to the user indicating driving directions. One example of processing in step 1544 by system 100 is depicted in FIG. 23. If the user did not request driving directions, in step 1546, system 100 terminates call processing and ends the call.

FIG. 16 is a flowchart for providing transactions related to auction services in one embodiment according to the present invention. FIG. 16 begins in step 1600.

A step 1602, system 100 collects auction partnership registration data associated with the user. Alternatively, in step 1604, system 100 transfers the user to one or more reverse auction partners based on the auction partnership registration data.

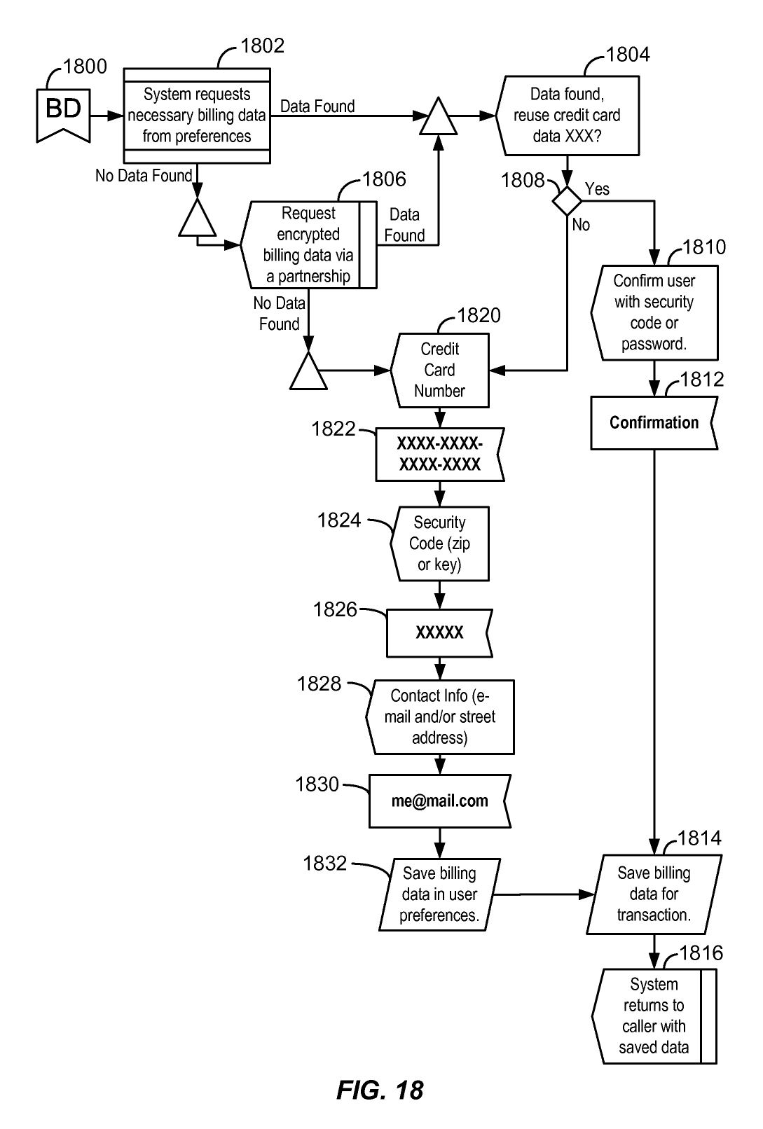

In step 1606, system 100 generates one or more messages to the user to interact with the user to obtain billing information. One example of processing in step 1606 by system 100 is depicted in FIG. 18.

In step 1608, system 100 receives verbal input from the user indicating a bid, such as a bid on airfares, hotels, transportation and activities, products and/or services. In step 1610, system 100 generates a message to the user indicating that the bid is being processed. For example, system 100 may generate a message to the user indicating a targeted ad while the bid is processed.

In step 1612, system 100 connects to one or more auction partners to submit the bid and awaits confirmation. In step 1614, system 100 generates a message to the user indicating that the bid was submitted. System 100 may also indicate to the user at the user will receive a call back indicating the results of the bid. In step 1616, system 100 terminates call processing and ends or disconnects the call with the user.

In step 1618, system 100 receives information associated with the bid. For example, system 100 may receive information indicating that the bid has been accepted, or that the bid has not been accepted and failed. In step 1620 system 100 updates the lowest price search and generates one or more targeted ads based on the information associated with the bid. In step 1622, system 100 caches the data before placing a call to the user. In step 1624, system 100 calls the user and generates a message to the user indicating the information associated with the bid. System 100 may generate a message to the user indicating the updated lowest priced data and a targeted ad.

If, in step 1626, system 100 determines that the bid was accepted, in step 1628, system 100 updates user preferences associated with the user. In step 1630, system 100 generates one or more messages to the user to interact with the user to confirm the order for purchase of the product (e.g., FIG. 17). If, in step 1626, system 100 determines that the bid failed, in step 1632, system 100 continues call procesing. In step 1634, system 100 generates a message to the user indicating the failure of the bid, and offers a targeted advertisement, the latest lowest price, and/or a chance to re-bid on the product and/or service.

If, in step 1626, system 100 receives verbal input from the user indicating that the user wishes to counter bid, in step 1636, system 100 continues call processing. In step 1638, system 100 receives a counter-offer from an auction partner, and generates a message to the user indicating the counter-offer made by the auction partner. In step 1640, system 100 receives verbal input from the user indicating whether the user accepts the counteroffer. If yes in step 1642, system 100 generates one or more messages to the user to interact with the user to confirm the order in step 1630 (e.g., FIG. 17). If no, in step 1644, system 100 continues call processing in step 1634.

In step 1646, system 100 receives verbal input from the user indicating whether the user wishes to enter a new bid, accept an offer in a targeted ad, and/or request a current lowest price for a product. In step 1648, system 100 determines that the users requesting the current lowest price for a product. In step 1650, system 100 returns the call to the previous flow state in step 1652. If the user accepts an offer in a targeted ad in step 1654, system 100 continues call processing such that the offer indicated in a targeted ad can be further processed by the system 100.

If, in step 1646, the user indicates to place a new bid, in step 1656, system 100 generates a message to the user indicating to place a new bid. In step 1658, system 100 generates a message to the user indicating that the user may need to update the itinerary and/or other product information to resubmit the bid. System 100 continues call processing in step 1608 for the user places (or replace) a bid.

FIG. 17 is a flowchart for providing transactions related to order confirmation services in one embodiment according to the present invention. FIG. 17 begins in step 1700.

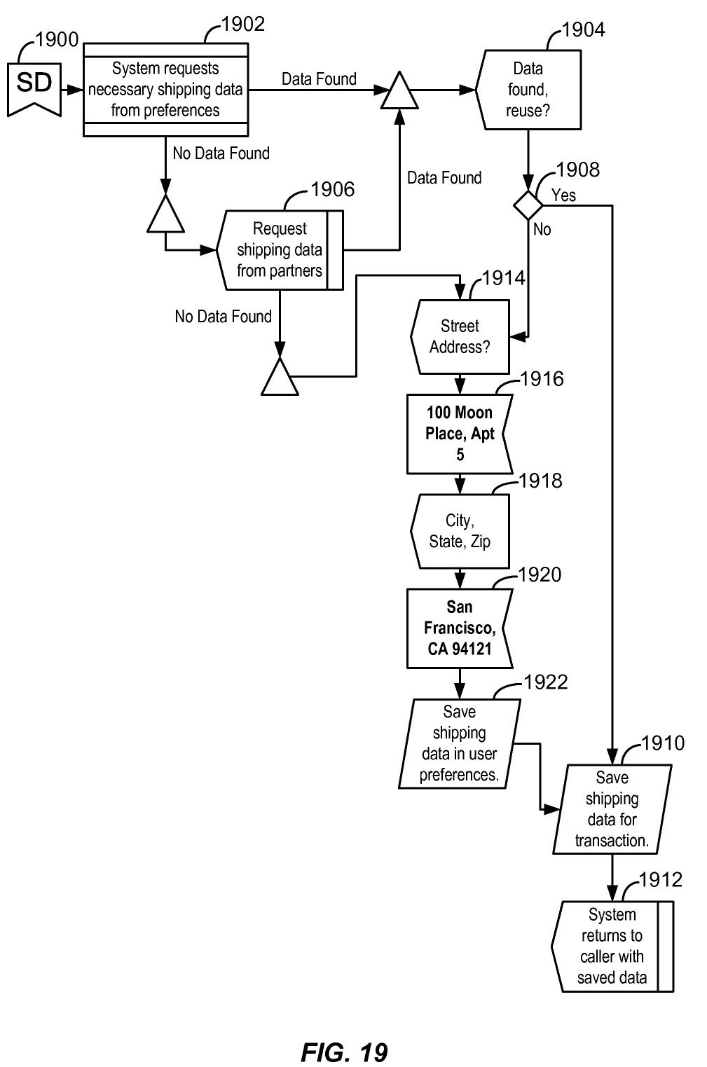

In step 1702, system 100 collect shipping information from the user for the transaction is needed. In step 1704, system 100 generates one or more messages to the user to interact with the user to obtain shipping information. One example of processing in step 1704 by system 100 is depicted in FIG. 19.

In step 1706, system 100 collects billing information from the user that has not already been collected or store stored in user profile data. In step 1708, system 100 generates one or more messages to the user to interact with the user to obtain billing information. One example of processing in step 1708 by system 100 is depicted in FIG. 18.

In step 1710, system 100 submits the order for processing. In step 1712, system 100 checks for targeted ads related to the order. In step 1714, system 100 generates one or more messages to the user indicating an offer in a targeted ad (e.g., FIG. 20). In step 1716, system 100 determines whether the user accepted the targeted ad. If, in step 1716, the user accepts the offer in a targeted ad, system 100 adds the advertised offer to a shopping cart in step 1718. System 100 then continues call processing in step 1710.

If, in step 1716, the user does not accept the targeted ad, system 100 receives confirmation numbers associated with the offer in step 1720. In step 1722, system 100 generates a message to the user indicating the confirmation number. In step 1724, system 100 generates a message to the user indicating offers to set date and location sensitive alerts for the user appropriate to the transaction.

If, in step 1726, system 100 receives verbal input from the user indicating that the user wishes to set date and location sensitive alerts, in step 1728, system 100 generates one or more messages to the user to interact with the user provide the date and location sensitive alerts. One example of processing in step 1728 by system 100 is depicted in FIG. 21.

If, in step 1726, system 100 receives verbal input from the user indicating that the user does not wish to receive date and location sensitive alerts, in step 1730, system 100 terminates the call and ends call processing.

FIG. 18 is a flowchart for providing transactions related to financial services in one embodiment according to the present invention. FIG. 18 begins in step 1800.

In step 1802, system 100 requests billing information from user stored preferences. If system 100 attains billing information from the user's stored preferences, in step 1804, system 100 generates a message to the user indicating whether the user wishes to reuse this word billing information.

If system 100 does not obtain billing information from the user stored preferences, in step 1806, system 100 requests billing information for the user from a financial partners. In various embodiments, the billing information is encrypted to preserve privacy of the user. If the system 100 attains billing information for the user from the partnership in step 1806, system 100 generates a message to the user instant 1804 indicating whether the user wishes to reuse word billing information.

In step 1808, system 100 receives verbal input from the user indicating whether the user wishes to reuse the billing information. If the user wishes to reuse the stored billing information, in step 1810, system 100 generates a message to the user indicating to the user to confirm the billing information with a security code or password. In step 1812, system 100 receives verbal input from the user indicating confirmation of the billing information. In step 1814, system 100 saves the billing information for the transaction. In step 1816, system 100 returns the caller to call processing.

Alternatively, if system 100 does not obtain stored billing information for the user in step 1806, or if, in step 1808, the user does not wish to reuse the stored billing information, in step 1820, system 100 generates a message to the user indicating a request for billing information from the user. For example, system 100 may generate a message indicating a request for a credit card number. In step 1822, system 100 receives verbal input from the user indicating billing information, such as a credit card number. In step 1824, system 100 generates a message indicating a request for a security code for using the credit card number. In step 1826, system 100 receives verbal input from the user indicating a security code for using the credit card number.

In step 1826, system 100 generates a message to the user indicating a request for contact information, such as e-mail address, street address and the like. In step 1830, system 100 receives verbal input from the user indicating contact information, such as an e-mail address. In step 1832, system 100 saves the billing information for the user in the user's preferences. System 100 then returns to call processing in step 1814.

FIG. 19 is a flowchart for providing transactions related to shipping services in one embodiment according to the present invention. FIG. 19 begins in step 1900.

In step 1902, system 100 determines shipping information from user profile data associated with the user. If shipping information is found in the user profile data associated with the user, in step 1904, system 100 generates a message to the user indicating whether the user wishes to reuse the shipping information.

If shipping information is not found in the user profile data associated with the user, in step 1906, system 100 requests shipping information from one or more shipping partners. If shipping information is received for the user from the one or more shipping partners, system 100 requests confirmation to reuse the shipping information in step 1904.

In step 1908, system 100 receives verbal input from the user indicating whether the user wishes to reuse the stored or obtained shipping information. If, in step 1908, the user wishes to reuse the shipping information, in step 1910, system 100 saves the shipping information for the transaction. In step 1912, system 100 returns the caller to call processing.

Alternatively, if system 100 does not obtain shipping information from the one or more shipping partners in step 1906, or if, in step 1908, the user does not wish to reuse the shipping information, in step 1914, system 100 generates a message to the user indicating a request for shipping information. For example, system 100 may generate a message requesting the street address of the user. In step 1916, system 100 receives verbal input from the user indicating the user's street address. For example, a user may provide verbal input indicating “100 Moon Place, Apt. 5.”

In step 1920, system 100 generates a message to the user indicating a request for city, state, and ZIP code information. In step 1922, system 100 receives verbal input from the user indicating city, state, and zip code information. For example, a user may provide verbal input indicating “San Francisco, Calif. 94121.” In step 1922, system 100 saves the shipping information received from the user in the user's preferences. System 100 then returns to call processing in step 1910.

FIG. 20 is a flowchart for providing targeted advertising in one embodiment according to the present invention. FIG. 20 begins in step 2000.

In step 2002, system 100 checks for targeted ads that have been saved in the cache. In step 2004, system 100 identifies one or more targeted ads to be conveyed to the user. In various embodiments, system 100 identifies targeted ads that can be “upsells,” “snipes,” brand recognition, and promotions.

In step 2006, system 100 determines the type of ads available. If, in step 2006, system 100 determines that no targeted ads are available, in step 2008, system 100 returns the caller to call processing.

If, in step 2006, system 100 determines that no action ad spots are available, in step 2010, system 100 generates a message to the user indicating one or more offers are available to the user while the users waiting for information. For example, system 100 generates a message to the user indicating that while the users waiting for search results or for a confirmation number, “Acme has the lowest prices on DVDs in the San Francisco Bay area.”

If, in step 2006, system 100 determines that a targeted snipe ad is available, in step 2012, system 100 generates a message indicating to the user that one or more offers are available while the user waits for information, in an attempt to capture the user's purchase for the same product and/or service from a different vendor. If, in step 2006, system 100 determines that a targeted upsell ad is available, in step 2018, system 100 generates a message to the user indicating one or more offers are available while the user waits for information, in an attempt to capture the user's purchase for a different product and/or service from the same vendor or a different vendor.

In step 2014, system 100 receives verbal input from the user indicating whether the user accepts an offer in the conveyed in steps 2010, 2012, and 2018. If, in step 2014, system 100 determines that the user requests one of the offers in the targeted ads, in step 2016, system 100 saves the selected offered for the user. System 100 then returns the caller to call processing in step 2008. Additionally, if the user does not select one of the offers in the targeted ads in step 2014, system 100 returns the caller to call processing in step 2008.

FIG. 21 is a flowchart for providing personal information management services in one embodiment according to the present invention. FIG. 21 begins in step 2100.

In step 2102, system 100 generates a message to the user indicating one or more voice dialing features and storage of contacts, including full addresses. In step 2104, system 100 receives verbal input from the user indicating that the user wishes to save the listing requested by the user. In step 2106, system 100 saves the listing requested by the user as a recorded utterance in a user's profile data. In step 2108, system 100 determines how to route the user's call. If system 100 receives verbal input from the user indicating to return the caller to call processing, in step 2110, system 100 returns to call processing. If system 100 receives verbal input from the user indicating to terminate or end the call, in step 2112, system terminates the call.

Alternatively, in step 2104, if supported by a device associated with the user (e.g., laptop computer 102 or mobile device 104), system 100 may generate a message to the user to synchronize the listing requested by the user to laptop computer 102 or mobile device 104. In step 2114, system 100 synchronizes the listing to the device (e.g., via voice download, SMS, e-mail, vcard, and the like.) In step 2116, system 100 saves the listing to the user's device as a voice print. System 100 then returns to call processing in step 2108 to determine how to route the user's call.

In step 2118, system 100 receives verbal input from the user indicating that the user wishes to voice dial a contact from the user's profile data. In step 2120, system 100 determines the correct contact listing to dial. In step 2122, system 100 connects the user to the number associated with the contact. In step 2124, system 100 disconnects from the user, as the user continues the call with the contact.

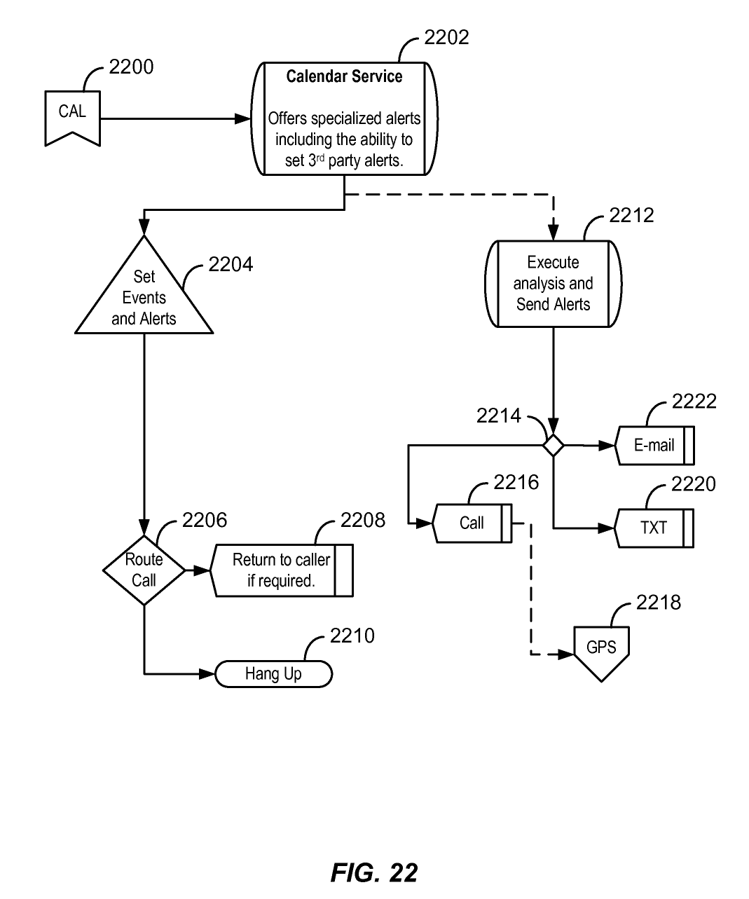

In step 2126, system 100 receives verbal input from the user indicating that the user wishes to set notifications and/or alerts. In step 2128, system 100 generates one or more messages to the user to interact with the user to set notifications and alerts for the user in the user's calendar. One example of processing in step 2128 by system 100 is depicted in FIG. 22.

In step 2130, system 100 receives verbal input from the user indicating that the user wishes to enter the unified messaging service. In one example, system 100 generates a message to the user indicating that the user may send and listen to voice messages, send and receive (or listen to) e-mail, and create or listen to text messages and memos. In step 2132, system 100 receives verbal input from the user to read messages, such as e-mail, text messages, and voice messages. In step 2134, system 100 receives verbal input from the user to send messages, such as e-mail, text messages, and voice messages. In step 2136, system 100 performs one of more tasks related to reading and/or sending messages.

FIG. 22 is a flowchart for providing calendaring services related to shipping services in one embodiment according to the present invention. FIG. 22 begins to step 2200.

In step 2202, system 100 generates a message to the user indicating whether the user wishes to set notifications and/or alerts in a user's calendar, or in a service provided by one or more calendar partners. In step 2204, system 100 receives verbal input from the user indicating to set one or more events and/or alerts in the user's calendar. In step 2206, system 100 returns the caller to call processing in step 2208, or terminates the call in step 2210.

Alternatively, in step 2212, system 100 analyzes the user's calendar to generate one or more notifications and/or alerts to the user. In step 2214, system 100 determines the type of notification and or alerts to be sent to the user. In step 2216, system 100 calls the user and generates a message to the user indicating information associated with the notification and/or alerts. In step 2218, system 100 may generate a message to the user indicating location-based services in response to the notification and/or alert.

In step 2220, system 100 generates a text message to the user indicating information associated with the notification and/or alert. In step 2222, system 100 generates an e-mail to the user indicating information associated with the notification and/or alert.

FIG. 23 is a flowchart for providing location-based services in one embodiment according to the present invention. FIG. 23 begins in step 2300.

In step 2302, system 100 receives verbal input from a user indicating to store forward and store directions. In step 2304, system 100 uses cellular location, GPS information, and/or E911 information, to determine the location of the caller. In step 2306, system 100 uses cellular location, GPS information, and/or the 911 information, to determine the location of the caller. In step 2308, system 100 determines directions for the user, or requests the directions from one or more location information partners.

In step 2310, system 100 receives verbal input from the user requesting point to point directions. In step 2312, system 100 uses cellular location information, GPS location information, E911 location information, to determine the location of the caller. In step 2314, system 100 generates a message to the user requesting the destination of the user. For example system 100 generates a message indicating “What is your destination?”

In step 2316, system 100 receives verbal input from the user indicating the users destination. For example, a user may provide verbal input indicating “Maggiano's in San Jose, Calif.” In step 2318, system 100 may generate a message to the user indicating a request for confirmation of the user's destination. For example system 100 may generate a message to the user indicating “Is that Maggiano's Little Italy?” In step 2320, system 100 receives verbal input from the user indicating confirmation of the user's destination. In step 2322, system 100 determines the point to point directions, or requests the directions from one or more location information partners.

FIG. 24 is a flowchart for providing transactions provided by partnership services in one embodiment according to the present invention. FIG. 24 begins in step 2400.

In step 2410 system 100 requests travel information from one or more travel information partners. For example, system 100 may obtain travel information from websites such as Sidestep.com, Lowfares.com (searches all the remaining), Orbitz, Travelocity, Expedia, Kayak, Priceline, Hotwire, CheapAir, CheapTickets, CHEAPOAIR, travelgrove, Farecast, and the like. In step 2420, system 100 may further request possible hotel information from one or more hotel information partners. For example, system 100 may request hotel information from websites, such as hotels.com, venere.com, booking.com, and the like.

In step 2430, system 100 requests product and/or service information from one or more shopping information partners. For example, system 100 may request product and/or service information from websites, such as Mysimon.com, Froogle.com, ShopZilla.com, eBay (including shopping.com), Overstock.com, pricescan.com, Shopping.MSN.com, Yahoo Shopping, Amazon.com, marketworks.com, and the like.

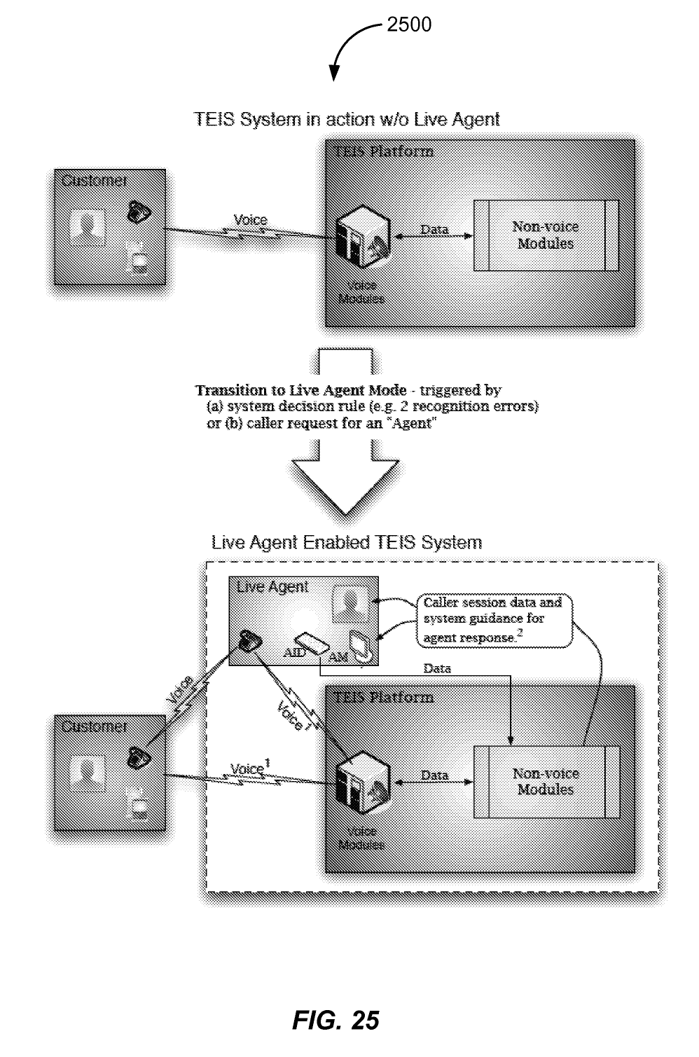

FIG. 25 is an illustration that depicts live-agent-enabled transaction-enable information system 2500 in various embodiments according to the present invention.

In various embodiments, “Live Agent” means a person who by one or more communications devices can be a party to input provided by a user of system 100. For example, a human agent of system 100 may hear utterances of a caller to system 100. In some embodiments, the live agent may in response respond to the caller, e.g., verbally—asking the caller for added information that the system 100 would otherwise ask for by automated means. In further embodiments, the live agent may in response respond to system 100 by making input to the system 100 based upon the live agent's understanding of the caller's intention (e.g., inputting a caller's travel requirements).

In various embodiments, system 100 may at any feasible point in time switch between automated mode and “Live Agent Mode.” “Live Agent Mode” refers to mode of operation of system 100 wherein the live agent, for example, hears a caller's utterances otherwise input into system 100 and responds with a verbal response to the caller and/or with input to system 100. The live agent may determine a response that is in accordance with system 100 in any number of ways, which include (but is not limited to) referring to a history of a caller's verbal inputs (e.g., as summarized on a computer monitor), decision rules, reading a script, referring to an outline, or from memory of the relevant decision rules. In some embodiment, there may be certain system responses that system 100 prescribes that a live agent, for security reasons, can not make, such as requesting a caller to verbally supply an identity verifying password. Accordingly, system 100 may switch to automated mode allowing the password to be dictated by the caller to system 100.

In various embodiments, system 100 may be designed to switch to the live agent mode automatically. This can occur when a specified requirement has been fulfilled (e.g., when system 100 has failed to recognize an utterance by a caller a certain number of times). System 100 may further be configured to switch to the live agent mode upon request. This can occur when a caller expresses an intention to proceed with the assistance of a live agent.

In one embodiment, after operating in the live agent mode, system 100 may switch back to operate without a live agent. (For example, system 100 can switch to live agent mode because system 100 failed to recognize the utterance of a caller after a specified number of attempts, whereupon a live agent, upon listening to such attempts, or added attempts, recognizes the intention of the caller, enters appropriate input into system 100, and system 100 then resumes operating in its automated mode, without the caller knowing that a live agent was involved. Alternatively, in other embodiments, after operating in the live agent mode, the call and the associated transaction can proceed to completion while remaining in that mode.

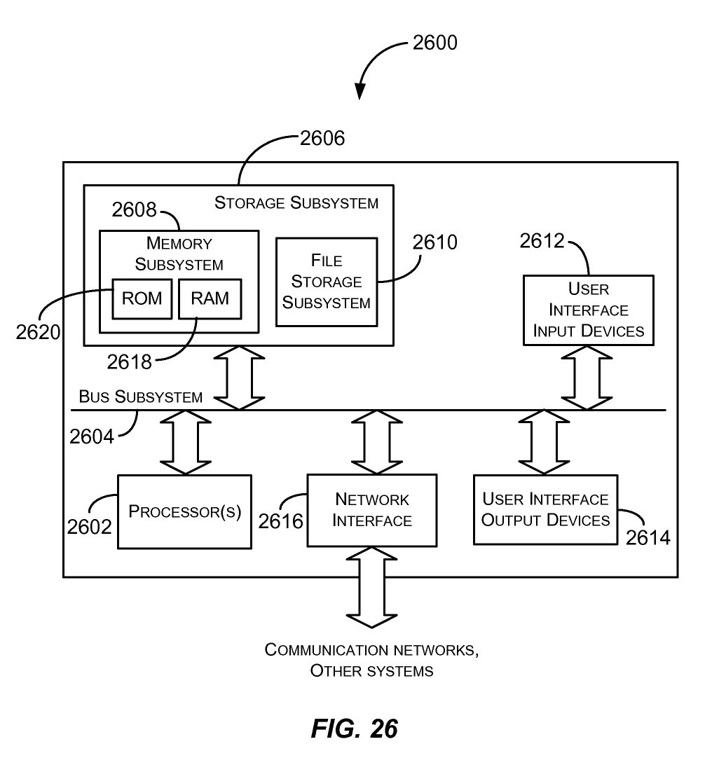

FIG. 26 is a simplified illustration of a computer system that may incorporate an embodiment of the present invention. FIG. 26 is merely illustrative of an embodiment incorporating the present invention and does not limit the scope of the invention as recited in the claims. One of ordinary skill in the art would recognize other variations, modifications, and alternatives.

As shown in FIG. 26, computer system 2600 includes a processor 2602 that communicates with a number of peripheral devices via a bus subsystem 2604. These peripheral devices may include a storage subsystem 2606, comprising a memory subsystem 2608 and a file storage subsystem 2610, user interface input devices 2612, user interface output devices 2614, and a network interface subsystem 2616.

Bus subsystem 2604 provides a mechanism for letting the various components and subsystems of computer system 2600 communicate with each other as intended. Although bus subsystem 2604 is shown schematically as a single bus, alternative embodiments of the bus subsystem may utilize multiple busses.

Network interface subsystem 2616 provides an interface to other computer systems, and networks, and devices. Network interface subsystem 2616 serves as an interface for receiving data from and transmitting data to other systems from computer system 2600.

User interface input devices 2612 may include a keyboard, pointing devices such as a mouse, trackball, touchpad, or graphics tablet, a scanner, a barcode scanner, a touchscreen incorporated into the display, audio input devices such as voice recognition systems, microphones, and other types of input devices. In general, use of the term “input device” is intended to include all possible types of devices and mechanisms for inputting information to computer system 2600.

User interface output devices 2614 may include a display subsystem, a printer, a fax machine, or non-visual displays such as audio output devices, etc. The display subsystem may be a cathode ray tube (CRT), a flat-panel device such as a liquid crystal display (LCD), or a projection device. In general, use of the term “output device” is intended to include all possible types of devices and mechanisms for outputting information from computer system 2600.

Storage subsystem 2606 may be configured to store the basic programming and data constructs that provide the functionality of the present invention. Software (code modules or instructions) that provides the functionality of the present invention may be stored in storage subsystem 2606. These software modules or instructions may be executed by processor(s) 2602. Storage subsystem 2606 may also provide a repository for storing data used in accordance with the present invention. Storage subsystem 2606 may comprise memory subsystem 2608 and file/disk storage subsystem 2610.

Memory subsystem 2608 may include a number of memories including a main random access memory (RAM) 2618 for storage of instructions and data during program execution and a read only memory (ROM) 2620 in which fixed instructions are stored. File storage subsystem 2610 provides persistent (non-volatile) storage for program and data files, and may include a hard disk drive, a floppy disk drive along with associated removable media, a Compact Disk Read Only Memory (CD-ROM) drive, a DVD, an optical drive, removable media cartridges, and other like storage media.

Computer system 2600 can be of various types including a personal computer, a portable computer, a workstation, a network computer, a mainframe, a kiosk, or any other data processing system. Due to the ever-changing nature of computers and networks, the description of computer system 2600 depicted in FIG. 26 is intended only as a specific example for purposes of illustrating the preferred embodiment of the computer system. Many other configurations having more or fewer components than the system depicted in FIG. 26 are possible.

The following is an abridged example of a call flow:

System 100: “What listing please?”

User: “United Airlines”

System 100: “Would you like me to help you find the lowest price for an airline ticket before I connect you to United Airlines?”

User: “Yes”

System 100 generates a system task create itinerary, search for lowest price for airline tickets based on itinerary, generate message to user indicating itinerary and lowest price

System 100: “The lowest price is $199.00 on Southwest Airlines. United Airlines is $499.00. Would you like to purchase a ticket from Southwest Airlines for $199.00, United Airlines for $499.00 or bid on this itinerary and save even more?”

User: “Yes, Southwest Airlines”

System 100 generates a system task to gather information from user to purchase ticket from Southwest Airlines at $199.00.

System 100: “Your reservation is complete. Would you like to set your phone alarm on the day of your departure or return?”

User: “Yes”

System 100 generates a system task to create an event in the user's calendar, and set an alarm on the days of departure and/or return.

System 100: “Would you like driving directions to the airport on your day of travel?”

User: “Yes”

System 100 generates a targeted ad indicating an offer to the user based on the user's itinerary.

System 100: “While you're in Seattle, would you like a free appetizer from the Metropolitan Grill located 1.1 miles from your hotel?”

User: “Yes”

System 100 generates system task to store offer for user.

System 100: “Would you like me to help you make a reservation?”

User: “Yes”

System 100 generates a system task to make the reservation.

System 100: “Would you like to receive driving directions to the Metropolitan Grill based on your GPS location with 15 minutes lead time?”

User: “Yes”

System 100 generates system task to determine driving directions, and conveys the driving directions to the user via voice, or to a mobile device associated with the user.

Although specific embodiments of the invention have been described, various modifications, alterations, alternative constructions, and equivalents are also encompassed within the scope of the invention. The described invention is not restricted to operation within certain specific data processing environments, but is free to operate within a plurality of data processing environments. Additionally, although the present invention has been described using a particular series of transactions and steps, it should be apparent to those skilled in the art that the scope of the present invention is not limited to the described series of transactions and steps.

Further, while the present invention has been described using a particular combination of hardware and software, it should be recognized that other combinations of hardware and software are also within the scope of the present invention. The present invention may be implemented only in hardware, or only in software, or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claims.

What is claimed is:

1. A method for providing live-agent-enabled transaction-enabled information, the method comprising:
receiving, at least one of one or more communications device operated by a human agent of an information service, a first information request from a user associated with a second communications device requesting information from the information service, the first information request indicative of one or more data elements;
determining, based on the one or more data elements, a transaction that satisfies criteria associated with requested information;
receiving, at least one of the one or more communications device operated by the human agent of the information service, a second information request from the user associated with the second communications device, the second information request indicative of whether the user wishes to initiate a buying decision process related to the transaction through the information service before being presented with the requested information; and
communicating, from at least one of the one or more communications device operated by the human agent of the information service, information to the user associated with the buying decision process related to the transaction based on an indicating that the user wishes to initiate the buying decision process related to the transaction through the information service.

2. The method of claim 1 wherein communicating, from at least one of the one or more communications device operated by the human agent of the information service, information to the user associated with the buying decision process related to the transaction comprises communicating information that enables the human agent to present to the user the lowest price offered for a product or service related to the requested information.

3. The method of claim 2 further comprising:
determining, with at least one of the one or more communications device operated by the human agent of the information service, availability of the product or service; and
communicating, from at least one of the one or more communications device operated by the human agent of the information service, information indicative of the availability of the product or service.

4. The method of claim 1 wherein communicating, from one at least one of the one or more communications device operated by the human agent of the information service, information to the user associated with the buying decision process related to the transaction comprises communicating information that enables the human agent to present to the user one or more itineraries associated with a product or service.

5. The method of claim 4 further comprising communicating, from at least one of the one or more communications device operated by the human agent of the information service, an offer to reserve at least one of the one or more itineraries associated with the product or service.

6. The method of claim 1 wherein communicating, from at least one of the one or more communications device operated by the human agent of the information service, information to the user associated with the buying decision process related to the transaction comprises communicating an advertisement indicative of a second transaction.

7. The method of claim 1 wherein determining, based on the one or more data elements, the transaction that satisfies criteria associated with requested information comprises determining the transaction using at least one of the one or more communications device operated by the human agent of the information service.

8. A computer-readable storage medium storing a computer program product executable by a computer system for implementing one or more of the steps of the method of claim 1.

9. A system including one or more communications device operated by a human agent of an information service, the system comprising means for implementing one or more of the steps of the method of claim 1.

10. A method for providing transaction-enabled information, the method comprising:
receiving, at one or more computer systems operated by an information service, a first information request from a user associated with a second communications device requesting information from the information service, the first information request indicative of one or more data elements;
determining, with the one or more computer systems, a transaction that satisfies criteria associated with requested information based on the one or more data elements;
receiving, at the one or more computer systems operated by the information service, a second information request from the user associated with the second communications device, the second information request indicative of whether the user wishes to initiate a buying decision process related to the transaction through the information service before being presented with the requested information; and
communicating, from the one or more computer systems operated by the information service, information to the user associated with the buying decision process related to the transaction based on an indicating that the user wishes to initiate the buying decision process related to the transaction through the information service.

11. The method of claim 10 wherein communicating, from the one or more computer systems operated by the information service, information to the user associated with the buying decision process related to the transaction comprises communicating information that enables a comparison shopping engine of the information service to present to the user the lowest price offered for a product or service related to the requested information.

12. The method of claim 11 further comprising:
determining, with the one or more computer systems operated by the information service, availability of the product or service; and
communicating, from the one or more computer systems operated by the information service, information indicative of the availability of the product or service.

13. The method of claim 10 wherein communicating, from the one or more computer systems operated by the information service, information to the user associated with the buying decision process related to the transaction comprises communicating information that enables a travel engine of the information service to determine one or more itineraries associated with a product or service.

14. The method of claim 13 further comprising communicating, from the one or more computer systems operated by the information service, an offer to reserve at least one of the one or more itineraries associated with the product or service.

15. The method of claim 10 wherein communicating, from the one or more computer systems operated by the information service, information to the user associated with the buying decision process related to the transaction comprises communicating an advertisement indicative of a second transaction.

16. The method of claim 10 further comprising determining, with the one or more computer systems, whether to initiate communication between the user and a human agent of the information service to assist with the buying decision process related to the transaction.

17. A computer-readable storage medium storing a computer program product executable by a computer system for implementing one or more of the steps of the method of claim 10.

18. A method for providing hybrid live-agent-enabled and automated-agent transaction-enabled information, the method comprising:
receiving, at least one of one or more communications device operated by a human agent of an information service or one or more computer systems operated by the information service, a first information request from a user associated with a second communications device requesting information from the information service, the first information request indicative of one or more data elements;
determining, based on the one or more data elements, a transaction that satisfies criteria associated with requested information;
receiving, at least one of one or more communications device operated by the human agent of the information service or the one or more computer systems operated by the information service, a second information request from the user associated with the second communications device, the second information request indicative of whether the user wishes to initiate a buying decision process related to the transaction through the information service before being presented with the requested information; and
communicating, from at least one of one or more communications device operated by the human agent of the information service or the one or more computer systems operated by the information service, information to the user associated with the buying decision process related to the transaction based on an indicating that the user wishes to initiate the buying decision process related to the transaction through the information service.

19. The method of claim 18 wherein communicating, from at least one of one or more communications device operated by the human agent of the information service or the one or more computer systems operated by the information service, information to the user associated with the buying decision process related to the transaction comprises communicating information that enables either the human agent or the one or more computer systems to present to the user the lowest price offered for a product or service related to the requested information.

20. The method of claim 19 further comprising:
determining, with at least one of one or more communications device operated by the human agent of the information service or the one or more computer systems operated by the information service, availability of the product or service; and
communicating, from at least one of one or more communications device operated by the human agent of the information service or the one or more computer systems operated by the information service, information indicative of the availability of the product or service.

21. The method of claim 18 wherein communicating, from at least one of one or more communications device operated by the human agent of the information service or the one or more computer systems operated by the information service, information to the user associated with the buying decision process related to the transaction comprises communicating information that enables the human agent or the one or more computer systems to present to the user one or more itineraries associated with a product or service.

22. The method of claim 21 further comprising communicating, from at least one of one or more communications device operated by the human agent of the information service or the one or more computer systems operated by the information service, an offer to reserve at least one of the one or more itineraries associated with the product or service.

23. The method of claim 18 wherein communicating, from at least one of one or more communications device operated by the human agent of the information service or the one or more computer systems operated by the information service, information to the user associated with the buying decision process related to the transaction comprises communicating an advertisement indicative of a second transaction.

24. The method of claim 18 wherein determining whether to proceed with the buying decision process using the human agent or the one or more computer systems.

25. A computer-readable storage medium storing a computer program product executable by a computer system for implementing one or more of the steps of the method of claim 18.
